(19) United States
(12) Patent Application Publication
(10) Pub. No.: US 2014/0319044 A1
(43) Pub. Date: Oct. 30, 2014

(54) NANOPARTICLE-FUNCTIONALIZED MEMBRANES, METHODS OF MAKING SAME, AND USES OF SAME

(71) Applicants: Emmanuel P. Giannelis, Ithaca, NY (US); Yue Wang, Hangzhou (CN); Menachem Elimelech, New Haven, CT (US); Alberto Tiraferri, Misano Adriatico (IT); Meagan S. Mauter, Pittsburgh, PA (US)

(72) Inventors: Emmanuel P. Giannelis, Ithaca, NY (US); Yue Wang, Hangzhou (CN); Menachem Elimelech, New Haven, CT (US); Alberto Tiraferri, Misano Adriatico (IT); Meagan S. Mauter, Pittsburgh, PA (US)

(73) Assignees: YALE UNIVERSITY, New Haven, CT (US); CORNELL UNIVERSITY, Ithaca, NY (US)

(21) Appl. No.: 14/122,535

(22) PCT Filed: May 29, 2012
(86) PCT No.: PCT/US12/39815

§ 371 Date: Jun. 5, 2014

Related U.S. Application Data
(60) Provisional application No. 61/490,806, filed on May 27, 2011.

(51) Int. Cl. B01D 71/68; C02F 3/12; B01D 61/00; B01D 61/14; B01D 69/12; B01D 61/02

(52) U.S. Cl. CPC B01D 71/68; B01D 69/127; B01D 61/025; B01D 61/002; B01D 61/027; B01D 61/147; C02F 3/1268; B01D 69/12
USPC 210/321.6; 210/490; 427/244; 427/539

(57) ABSTRACT

Nanoparticle functionalized membranes, where the surface of the membranes is nanoparticle functionalized. The nanoparticles closest to the membrane surface are covalently bonded to the membrane surface. For example, the membranes are forward osmosis, reverse osmosis, or ultrafiltration membranes. The membranes can be used in devices or water purification methods.

### CROSS-REFERENCE TO RELATED APPLICATIONS

This application claims priority to U.S. provisional patent application No. 61/490,806, filed May 27, 2011, the disclosure of which is incorporated herein by reference.

### FIELD OF THE INVENTION

The present invention generally relates to nanoparticle functionalized membranes.

### BACKGROUND OF THE INVENTION

Efficient treatment of non-traditional water sources, such as wastewater and highly saline water, is critical to water supply. Reverse osmosis (RO) and forward osmosis (FO) are promising membrane-based technologies to meet this challenge. However, these systems suffer from membrane fouling, e.g., biofouling and fouling by organic molecules, which negatively impacts water throughput and membrane life.

Ultrafiltration (UF) membranes perform critical pre-treatment functions in advanced water treatment processes. In operational systems, however, biofouling decreases membrane performance and increases the frequency and cost of chemical cleaning.

Decades after the introduction of polymeric membranes for water treatment applications, membranes are widely deployed for the removal of bacteria, viruses, macromolecules, organic compounds, and salts from contaminated feed streams. The majority of membranes are fabricated from inert polymeric materials designed either as a size-selective sieve or a dense barrier with high selectivity.

While polymeric membranes are widely considered state-of-the-art in water treatment, current membrane design suffers from low rejection of certain contaminants of concern and low resistance to fouling. Inactivation of microorganisms that attach to the membrane would delay the onset of biofilm formation. However, the primary attachment mechanism of microorganisms involves the secretion of protein-based adhesives. Additionally, many other organic molecules are present in feedstreams and contribute significantly to the decrease in process performance due to fouling.

### BRIEF SUMMARY OF THE INVENTION

The present invention provides nanoparticle functionalized membranes, methods of making such membranes, and uses of such membranes. The membranes can be used in devices, such as ultrafiltration devices, and methods of water purification.

In an aspect, the present invention provides nanoparticle-functionalized membranes. The membranes have one or more layers of nanoparticles. The nanoparticles are metal nanoparticles, metal oxide nanoparticles, inorganic oxide nanoparticles, or combinations thereof. The nanoparticles closest to the membrane surface are covalently bonded to the membrane surface. The membranes can be reverse osmosis, forward osmosis, and ultrafiltration membranes.

In an aspect, the present invention provides methods for making nanoparticle-functionalized membranes. In an embodiment, the present invention provides a nanoparticle-functionalized membrane made by a method described herein.

In an aspect, the present invention provides devices with nanoparticle surface-functionalized membranes. Examples of such devices include ultrafiltration devices, reverse osmosis (RO) devices, forward osmosis (FO) devices, pressure retarded osmosis (PRO) devices, nanofiltration (NF) devices, microfiltration (MF) devices, and membrane bioreactors (MBR).

In an aspect, the present invention provides purification of aqueous media methods using nanoparticle surface-functionalized membranes. In an embodiment, nanoparticle-functionalized ultrafiltration, RO, or FO membranes can be used in water purification methods.

### BRIEF DESCRIPTION OF THE FIGURES

FIG. 1. An example of a post-synthesis grafting process for the fabrication of reactive membranes. Oxygen plasma activates the membrane skin layer with the addition of reactive and/or charged functional groups. The activated membrane is subsequently incubated with charged or functionalized nanoparticles. Electrostatic and covalent bonds form a persistent coating of reactive nanoparticles on the membrane surface.

FIG. 2. Material properties of examples of AgNPs and a PSf membrane. A) Transmission electron micrograph (TEM) of PEI functionalized AgNPs. B) Scanning electron micrograph (SEM) of the PSf membrane cross-section shows finger-like pore morphology. C) SEM of the membrane surface prior to plasma treatment and PEI-AgNP functionalization.

FIG. 3. Material properties of examples of modified membranes. A) Percent membrane surface oxygen content determined by XPS analysis as a function of O₂ plasma treatment time. B) ζ potential of unfunctionalized and functionalized membranes as a function of pH. C) Contact angle of untreated and treated membranes as a function of pH.

FIG. 4. Separation properties of examples of modified membranes. A) Molecular weight cutoff (MWCO) as a function of plasma treatment time for PEO molecules of varying molecular weights. B) Rejection as a function of the molecular weight of PEO. C) Pure water membrane permeability of modified membranes.

FIG. 5. A) XPS data of an exemplary membrane surface before and after modification with EDC AgNPs. Silver accounts for 5.2% of the atomic concentration at the membrane surface, B) Antimicrobial activity (expressed as residual live cells on the membrane) of exemplary untreated PSf, PEI coated, PEI-AgNP modified, and PEI-AgNP modified in the presence of EDC membrane surfaces. C) Ag+ ion release rates from a PEI-AgNPs coated membrane without EDC.

FIG. 6. An example of a 1-ethyl-3-(3-dimethylaminopropyl) carbodiimide hydrochloride (EDC) facilitated reaction. EDC reacts with carboxyl functionalities to form an amine-reactive O-acylisourea intermediate. This intermediate may react with a primary amine on the PEI coated AgNP, yielding a stable amide bond and an isourea by-product. If the intermediate does not react with an amine, it hydrolyzes and the carboxyl group is restored.

FIG. 7. Surface charge density of an exemplary unmodified polysulfone (PSf) membrane and the PSf membrane after 60 seconds oxygen plasma treatment assessed via cationic toluidine blue O chemisorption to anionic membrane surfaces.

FIG. 8. Attenuated total reflectance Fourier transform infrared (ATR-FTIR) spectra and peak identification table for exemplary PSf thin-films during critical steps in surface modification.

FIG. 9. An example of a polyamide membrane coated with silver nanoparticles. The bars are 1 micron (top) and 100 nm (bottom).

FIG. 10. XPS of an exemplary treated membrane confirming the presence of silver.

FIG. 11. Cytotoxic studies of exemplary Ag nanoparticle-modified membranes. Values represent average of two separately modified membranes.

FIG. 12. An exemplary schematic of the functionalized nanoparticles and of the protocol to functionalize the thin-film composite polyamide forward osmosis membranes used in this invention. Polyamide membranes possess native carboxylic groups at their surfaces that can be exploited as binding sites for the functionalization with tailored nanoparticles. Two different ligands were used to tailor the surface of nanoparticles rendering them superhydrophilic and optimizing their interaction with the membrane surface.

FIG. 13. Size, electrophoretic mobility, and thermogravimetric analysis of exemplary functionalized silica nanoparticles. The measured size and electrophoretic mobility of the nanoparticles in deionized water and in an electrolyte solution representative of a typical wastewater effluent (0.45 mM KH₂PO₄, 9.20 mM NaCl, 0.61 mM MgSO₄, 0.5 NaHCO₃, 0.5 mM CaCl₂, and 0.93 mM NH₄Cl)) are presented in the table. A) and B) show TEM images of silica nanoparticles silanized with —N(CH3)₃⁺-terminated chains and —NH₂-terminated chains, respectively. The plots on the right present TGA data for the C) bare silica nanoparticles as well as for the D-E) functionalized nanoparticles. The thermogravimetric plot (line) refers to the left axis and the differential thermogravimetric plot (hollow circles) refers to the right axis. Both data sets were normalized by the initial sample mass.

FIG. 14. XPS analysis of the surface of exemplary membranes. A) XPS survey scan of control polyamide membranes, and of membranes functionalized with silica nanoparticles silanized with —N(CH3)₃⁺-terminated chains and —NH₂-terminated chains, B-C-D) fractions of oxygen (O), carbon (C), nitrogen (N), and silica (Si) relative to the sum of these elements present at the surface of the three different membranes. The elemental fraction was calculated using software CasaXPS from the scans of FIG. 14A. The two functionalized membranes show the presence of significant amount of silica at their surface.

FIG. 15. Zeta potential of the surface of exemplary membranes as a function of solution pH. A) Zeta potentials of polyamide control membranes, and B-C) zeta potentials of membranes functionalized with silica nanoparticles silanized with —N(CH3)₃⁺-terminated chains and —NH₂-terminated chains, respectively. Zeta potential values were measured and calculated for at least 4 separately cast and functionalized samples for each membrane type, across a pH range from approximately 4 to 9. The data related to different samples were placed in the same plot and represented by different symbols. Measurements were taken at room temperature (23° C.), in solution of 1 mM KCl, and by adjusting the pH with appropriate amounts of HCl or KOH.

FIG. 16. Surface morphology and roughness of exemplary membranes from SEM and AFM analyses. Surface SEM micrographs of A-B) polyamide control membranes, C-D) membranes functionalized with silica nanoparticles silanized with —N(CH₃)₃⁺-terminated chains, and E-F) membranes functionalized with silica nanoparticles silanized with —NH₂-terminated chains. Panels A, C, and E are low magnification micrographs, while panels B, D, and F are higher magnification surface images. G) AFM images of a control polyamide membrane. H) roughness parameters measured by AFM tapping mode analysis. Here, RMS is root mean square of roughness, Rₘₐₓ/10 is maximum roughness divided by a factor of 10, Rₐ is average roughness, and SAD is percentage surface area difference. The bars refer to polyamide membranes, and membranes functionalized with —N(CH₃)₃⁺- and —NH₂-coated nanoparticles, respectively. Roughness values are the average of measurements on a total of 12 random spots on 3 separately cast and functionalized sample surfaces.

FIG. 17. Contact angles of deionized water on the surface of exemplary membranes for A) membranes functionalized with silica nanoparticles silanized with —N(CH3)₃⁺-terminated chains, and B) membranes functionalized with silica nanoparticles silanized with —NH₂-terminated chains. The contact angle of DI water on control polyamide membranes is shown in both plots as a patterned bar. The plots show values of the membranes as-functionalized (solid bars), and after the surface was subjected to stress (hollow bars), as briefly labeled in the graphs on each bar and as described in the discussion. Values are average of at least 8 random spots on each sample. Measurements were carried out at room temperature (23° C.), without addition of ionic strength, and at unadjusted pH. When contact angles were too low to be accurately measured, a value of 10 degrees was assumed for the calculations. Representative pictures of DI water droplets are included on the right for illustration purposes.

FIG. 18. Wettability, hydrophilicity, and surface energy of the surface of exemplary membranes. A) wettability with DI water, −ΔG_{ML}, and of hydrophilicity, ΔG^{TOT}_{MLM}, and B) calculated values of surface energy, γ^{TOT}. Data for polyamide control membranes are presented as patterned bars. Values for membranes functionalized with silica nanoparticles silanized with —N(CH₃)₃⁺-terminated chains or with —NH₂-terminated chains. The surface energy parameters were calculated from average contact angles measured with DI water, glycerol, and diiodomethane at room temperature (23° C.), without addition of ionic strength, and at unadjusted pH. At least 25 contact angles on at least 3 separately cast and functionalized sample were measured for each liquid and for each membrane type.

FIG. 19. Representative AFM retraction curves for foulant-membrane interaction using a A) BSA-fouled tip, and B) alginate-fouled tip. Data for control polyamide and for membranes functionalized with —N(CH₃)₃⁺-terminated nanoparticles. The average, minimum, and maximum values of the minimum energy wells measured for 125 separate retracting curves are reported for each foulant. The “No” label stands for measurements where no adhesion force was observed. The test solution for the measurements is synthetic wastewater as described in the experimental section. Measurements were carried out at room temperature (23° C.).

FIG. 20. ATR-IR shows the appearance of a shoulder for exemplary functionalized membranes around 1060-1100 cm⁻¹. An absorption peak around 1070-1080 cm⁻¹ is commonly attributed to stretching mode of Si—O—Si bonds, confirming the presence of silanized SiO₂ particles at the membrane surface.

FIG. 21. XPS and SEM analyses performed after membranes functionalized with nanoparticles were coated with —N(CH₃)₃⁺-terminated ligands show results within experimental error with those obtained on membranes as functionalized, suggesting the irreversibility of the functionalization.

FIG. 22. Statistics of foulant-membrane interaction forces measured by AFM. Data for control polyamide and for membranes functionalized with —N(CH₃)₃⁺-functionalized nanoparticles. Plot 22A shows data for BSA-fouled tip, while plot 22B presents results obtained using an alginate-fouled tip. The average, median, standard deviation, 1st, 5th, 95th, and 99th percentile are shown for 125 separate retracting curves. The test solution for the measurements is synthetic wastewater as described in the experimental section. Measurements were carried out at room temperature (23° C.).

FIG. 23. Transport parameters of exemplary fabricated membranes. The intrinsic water permeability of the active layer, A, the solute permeability coefficient of the active layer, B, and the structural parameter of the support layer, S, are presented as bars for the control polyamide membranes and for the superhydrophilic membranes functionalized with silica nanoparticles silanized with —N(CH₃)₃⁺-terminated chains. Values are average of at least 6 separately cast and functionalized samples for each membrane type. Error bars represent one standard deviation.

FIG. 24. Forward osmosis organic fouling of control polyamide membranes and functionalized superhydrophilic membranes: A) alginate, B) BSA, and C) Suwannee River natural organic matter (SRNOM). The percentage of water flux in FO at the end of the 8-hour fouling step relative to the initial water flux is shown as patterned bars. The percentage of water flux in FO recovered after the ‘physical’ cleaning step is shown as solid bars. Duplicates are shown for each membrane type. Fouling conditions were as follows: feed solution as described in Table 2 with 150 mg/L organic foulant (alginate, BSA, or SRNOM), initial water flux of 19 L m⁻² h⁻¹, cross-flow velocity of 21.4 cm/second, for a total of 8 hours of fouling. Cleaning conditions were as follows: foulant-free feed solution of 15 mM NaCl, no permeate water flux, cross-flow velocity of 21.4 cm/second, air bubbles introduced every 3 minutes, for a total cleaning time of 15 minutes. Temperature was maintained at 25° C.

FIG. 25. Comparison of organic fouling in RO and FO for control polyamide membranes and functionalized superhydrophilic membranes: A) alginate, B) BSA, and C) Suwannee River natural organic matter (SRNOM). The percentage of water flux at the end of the 8-hour fouling step relative to the initial water flux is shown as pattern (FO) and hollow (RO) bars. The percentage of water flux recovered after the ‘physical’ cleaning step is shown as solid bars. Fouling conditions were as follows: feed solution as described in Table 2 with 150 mg/L organic foulant (alginate, BSA, or SRNOM), initial water flux of 19 L m⁻² h⁻¹, cross-flow of 21.4 cm/second, for a total of 8 hours. Cleaning conditions were as follows: foulant-free feed solution of 15 mM NaCl, no permeate water flux, cross-flow velocity of 21.4 cm/second, air bubbles introduced every 3 minutes, for a total cleaning time of 15 minutes. Temperature was maintained at 25° C.

FIG. 26. Adhesion force measurements of foulant-membrane interaction by AFM contact mode. The different plots refer to interactions between membrane surfaces and a CML-modified latex particle AFM probe fouled with: A) alginate, B) BSA, and C) Suwannee River NOM (SRNOM). Values related to the control polyamide membranes are presented as pattern bars, whereas data measured for the functionalized superhydrophilic membranes. The “No” label at positive force values stands for measurements where no adhesion force was observed. The test solution chemistry for the measurements is as described in Table 2. At least 25 retracting tip measurements on 5 random spots were taken for each sample at room temperature (23° C.). Note the graphs are plotted with a different scale for the x axis. Also presented are the corresponding average values of average adhesion force, rupture distance, and interaction energy calculated as the negative area in the force vs. distance curve.

FIG. 27. Adhesion force measurements of foulant-foulant interaction by AFM contact mode. The different plots refer to interactions between membrane surfaces and a CML-modified latex particle AFM probe both fouled with: A) alginate, B) BSA, and C) SRNOM. Values related to the fouled control polyamide membranes are presented as bars, whereas data measured on the fouled functionalized superhydrophilic membranes are shown as pattern bars. The “No” label at positive force values stands for measurements where no adhesion force was observed. The test solution for the measurements is as described in Table 2. At least 25 retracting tip measurements on 5 random spots were taken for each sample at room temperature (23° C.). Please note the graphs are plotted with a different scale for the x axis. Also presented are the corresponding average values of average adhesion force, rupture distance, and interaction energy calculated as the negative area in the force vs. distance curve.

FIG. 28. Surface physicochemical properties of the functionalized membranes. A) Contact angles of deionized water on the surface of the membranes. The contact angle of DI water on control polyamide membranes is shown as a patterned bar. The plot shows values of the membranes as-functionalized (solid bars), and after the surface was subjected to stress (hollow bars), as briefly labeled in the graphs. Values are average of at least 8 random spots on each sample. Measurements were carried out at room temperature (23° C.), without addition of ionic strength, and at unadjusted pH. When contact angles were too low to be accurately measured, a value of 10 degrees was assumed for the calculations. B-C) Surface morphology of the functionalized membranes from SEM analysis. The table at the top presents values of average roughness measured by AFM imaging, zeta potential, and surface energies calculated from average contact angles measured with DI water, glycerol, and diiodomethane, for both control and functionalized membranes.

FIG. 29. Representative fouling curves. Curves of organic fouling experiments in FO are presented in the left column. The right column presents data for RO fouling experiments. The different rows refer to alginate (first row), BSA (second row), and SRNOM (third row) foulants, respectively. Curves related to control polyamide membranes are presented as squares, while data obtained using functionalized membranes are shown as circles. Fouling conditions were as follows: feed solution as described in Table 2 with 150 mg/L foulant, initial water flux of approximately 19 L m⁻² h⁻¹, cross-flow of 21.4 cm/second, for a total of 8 hours. Cleaning conditions were as follows: foulant-free feed solution of 15 mM NaCl, no flux, cross-flow of 21.4 cm/second, air bubbles introduced every 3 minutes, for a total of 15 minutes. Temperature was maintained at 25° C. Shown data points for FO fouling are the moving averages of recorded data in time windows of 18 minutes, to eliminate the experimental noise.

FIG. 30. Rupture distance measurements of foulant-membrane (left column) and foulant-foulant (right column) interaction by AFM contact mode. The different rows refer to interactions between membrane surfaces and a CML-modified latex particle glued on the AFM probe fouled with (first row) alginate, (second row) BSA, and (third row) SRNOM. Values related to the control polyamide membranes are presented as bars, whereas data measured on the functionalized superhydrophilic membranes are shown as bars. The test solution for the measurements is as described in Table 2. At least 25 retracting tip measurements on 5 random spots were taken for each sample at room temperature (23° C.).

FIG. 31. Adhesion force (left) and rupture distance (right) measurements of latex particle-membrane interaction by AFM contact mode. The latex particle is carboxylate modified by copolymerization with carboxylic acid containing polymers. Values related to the control polyamide membranes are presented as patterned bars, whereas data measured on the functionalized superhydrophilic membranes are shown as bars. The test solution for the measurements is as described in Table 2. At least 25 retracting tip measurements on 5 random spots were taken for each sample at room temperature (23° C.).

FIG. 32. Normalized flux after fouling in FO (solid symbols) and RO (hollow symbols) plotted against the work of adhesion, calculated as the negative area in the force vs. distance curves from AFM measurements of intermolecular forces. Values related to the control polyamide membranes are presented as squares, whereas data measured on the functionalized superhydrophilic membranes are shown as circles. The test solution for the measurements is as described in Table 2. At least 25 retracting tip measurements on 5 random spots were taken for each sample at room temperature (23° C.).

### DETAILED DESCRIPTION OF THE INVENTION

The present invention provides nanoparticle functionalized membranes, methods of making such membranes, and uses of such membranes. The membranes can be used in devices, such as ultrafiltration devices, and methods of water purification.

The present invention is based on the surprising result that membranes can be surface functionalized with nanoparticles without degrading certain properties of the membranes. For example, the nanoparticle-functionalized membranes exhibit desirable characteristics such as biocidal, anti-fouling, and self-cleaning properties.

The nanoparticles can impart biocidal properties to, for example, polyamide membranes and control their biofouling. The surface functionalization of the membranes concentrates nanoparticle activity at the membrane surface. Surface-functionalized membranes offer a number of advantages over mixed-matrix membranes. A benefit is concentration of nanoparticles at the membrane surface where reaction that can inhibit biofouling occurs and avoiding challenges associated with nanoparticle/polymer compatibility, which lead typically to the presence of voids and defects in the membrane. Other benefits include manufacturing scalability, the range of membrane and nanomaterial functionalization options, and reduced cost stemming from more efficient utilization of the reactive nanoparticles.

In an aspect, the present invention provides nanoparticle-functionalized membranes. The membranes have one or more layers of nanoparticles. The layer of nanoparticles closest to the membrane surface are covalently bonded to the membrane surface. The nanoparticles other than those closest to the membrane surface are electrostatically bonded to at least one other nanoparticle. Chemically bonded as used herein includes covalent bonding and electrostatic bonding (e.g., ionic bonding and hydrogen bonding).

In an embodiment, the nanoparticle-functionalized membranes have one or more layers of nanoparticles chemically bonded to the membrane surface. A first layer of nanoparticles is covalently bonded and/or electrostatically bonded to the membrane surface and the other layer or layers, if any, are electrostatically bonded to the nanoparticles of the first layer of nanoparticles.

A variety of membranes can be used. For example, the membranes can be reverse-osmosis (RO) membranes, forward-osmosis (FO) membranes, or ultrafiltration membranes. In an embodiment, the membranes are porous membranes such as ultrafiltration membranes. In another embodiment, the membranes are semi-permeable membranes such as reverse-osmosis membranes or forward-osmosis membranes. Examples of suitable membranes include RO or FO membranes made from an aliphatic or aromatic polyamide, aromatic polyhydrazide, poly-benzimidazolone, poly(epiamine/amide), poly(epiamine/urea), poly(ethyleneimine/urea), sulfonated polyfurane, polybenzimidazole, poly(piperazine/isophtalamide), polyethers, poly(ether/urea), polyester, polyimide, or a copolymer thereof, or a mixture thereof. Examples of suitable membranes include ultrafiltration membranes made from polysulfone, polyethersulfone, poly(ether sulfone ketone), poly(ether ethyl ketone), poly(phthalazinone ether sulfone ketone), polyacrylonitrile, polypropylene, poly(vinyl fluoride), polyetherimide, cellulose acetate, cellulose diacetate, and cellulose triacetate polyacrylonitrile. The membranes can be fabricated by methods known in the art. Suitable membranes are commercially available. For example, thin-film composite polyamide membranes such as SW30 from Dow Chemical Company or others from Oasys, Toray, Hydranautics, asymmetric membranes for FO from Hydration Technology, asymmetric membranes for UF from SepRO, Koch, and GE can be used.

The membranes can be composite membranes. The composite membranes comprise an active membrane layer (also referred to as a skin layer) and one or more inactive membrane layers (also referred to as support layers). The active membrane layer has a first surface in contact with a surface of an inactive membrane layer. The active layer is a nanoparticle-functionalized membrane. The nanoparticle-functionalized surface of the active membrane layer is opposite the surface of the active layer in contact with the inactive layer. The inactive membrane layers are not nanoparticle-functionalized membranes. The inactive membrane layers can be support layers. The inactive membrane layers can be porous. Such support layers are known in the art. Examples of suitable inactive layers include layers made from polysulfone, polyethersulfone, poly(ether sulfone ketone), poly(ether ethyl ketone), poly(phthalazinone ether sulfone ketone), polyacrylonitrile, polypropylene, poly(vinyl fluoride), polyetherimide, cellulose acetate, cellulose diacetate, and cellulose triacetate polyacrylonitrile. For example, the inactive layer can be a non-woven polyethylene terephthalate (PET) layer.

The nanoparticles are chemically bonded (e.g., covalently bonded and/or electrostatically bonded) to the membrane or other nanoparticles. The nanoparticles disposed on the surface of the membrane are chemically bonded to the membrane surface. For example, the nanoparticles are chemically bonded to the membrane surface via a linker group. Examples of suitable linker groups include groups derived from aminosilanes, aminothiols, aminophosphine oxides, and aminophosphates. The amine groups can be primary, secondary, tertiary or quaternary. Examples of suitable linker groups include alkyl siloxane groups such as

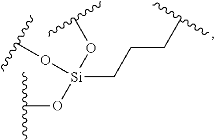 [SMILES: *CCC[Si](O*)(O*)O*]

alkyl thiol groups, and alkyl phosphate groups. In another example, the nanoparticles are chemically bonded to the membrane surface through a polymer. Examples of suitable polymers include positively charged polymers or polymers containing amine groups. The amine groups can be primary, secondary, tertiary or quaternary. Polyethyleneimine is an example of a polymer that can be used. The polymer at least partially covers the nanoparticle surface. For example, polyethyleneimine (PEI) can provide an alkyl amine linker group such as

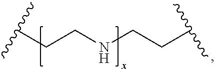

where x depends on the molecular weight of the PEI.

The nanoparticles not disposed on the surface of the membrane are electrostatically bonded to nanoparticles disposed on the surface of the membrane. It is considered the membranes have one or more layers of nanoparticles. For example, the membrane has from 1 to 10 layers of nanoparticles, including all integer numbers of layers and ranges therebetween.

The nanoparticles are metal nanoparticles, metal oxide nanoparticles, or inorganic nanoparticles. Combinations of such nanoparticles can be used. Examples of suitable metal nanoparticles include silver, copper, aluminum, zinc, iron, manganese, nickel, tungsten, zirconium, and hafnium nanoparticles. Examples of suitable metal oxide nanoparticles include titanium dioxide nanoparticles. Examples of inorganic oxide nanoparticles include silicon dioxide nanoparticles.

Nanoparticles of various sizes can be used. For example, nanoparticles having a size of from 1 nm to 500 nm, including all integer values and ranges therebetween. In the case of porous membranes, it can be desirable that the nanoparticles be smaller than the diameter of the pores of the membrane.

The nanoparticles can be hydrophilic (also referred to herein as superhydrophilic) nanoparticles. The hydrophilic nanoparticles are silica nanoparticles that are surface functionalized with alkyl siloxane linker groups. Membranes surface-functionalized with hydrophilic nanoparticles can provide a hydrophilic surface. By hydrophilic surface it is meant that surface has a contact angle less than 30 degrees. In various examples, the functionalized membrane has a contact angle of less than 30 degrees, 25 degrees, 20 degrees, 15 degrees, 10 degrees, or 5 degrees. Without intending to be bound by any particular theory, it is considered that the strong hydration layer of the hydrophilic surface resists the adsorption of molecules and particles to the membrane surface, resulting in anti-fouling resistance.

The nanoparticles can be made by methods known in the art. For example, the surface functionalized nanoparticles can be formed in situ by contacting a solution of a nanoparticle precursor compound (e.g., AgNO₃) with a polymer (e.g., polyethyleneimine) in the presence of a reducing agent, for example sodium borohydride, such that silver nanoparticles in a polymer matrix are formed. Suitable nanoparticles are commercially available.

The nanoparticle-functionalized membranes can have desirable characteristics. For example, nanoparticle functionalized RO/FO membranes have 50 to 100% rejection of NaCl, including all integer percentages and ranges therebetween, and nanoparticle functionalized ultrafiltration membranes have 50 to 100% rejection of macromolecules with a molecular weight greater than 1000 Da, including all integer percentages and ranges therebetween. For example, nanoparticle functionalized RO and FO membranes have a permeability of 0.1 to 10 liter per square meter per hour per bar, including all values to the 0.1 liter per square meter per hour per bar and ranges therebetween, and nanoparticle functionalized UF membranes have a permeability of 10 to 100 liter per square meter per hour per bar, including all integer liter per square meter per hour per bar values and ranges therebetween. Also, treating the surface-functionalized membranes with different solvents or changing the pH does not lead to leaching of the nanoparticles.

The nanoparticle-functionalized membranes can have properties substantially the same as those of similar membranes that are not nanoparticle-functionalized. By “substantially similar” it is meant that one or more properties of the nanoparticle-functionalized membranes differs (i.e., is increased or decreased depending on the property) by less than 20% from that of a comparable unfunctionalized membrane. In various examples, one or more properties of the nanoparticle-functionalized membranes differ by less than 15%, 10%, 5%, or 1% from that of a comparable unfunctionalized membrane. The properties include flux, rejection, permeability, chemical resistance, and mechanical resistance.

In an aspect, the present invention provides methods for making nanoparticle-functionalized membranes. In an embodiment, the present invention provides a nanoparticle-functionalized membrane made by a method described herein.

In an embodiment, a method for forming a nanoparticle-functionalized membrane comprising the steps of: optionally, functionalizing a membrane such that reactive functional groups are formed on the membrane surface; and contacting the membrane with surface-functionalized nanoparticles such that the reactive functional groups on the membrane surface react with the surface-functionalized nanoparticles forming a nanoparticle-functionalized membrane.

In an embodiment, the membrane is contacted with surface-functionalized nanoparticles and a crosslinking agent. The crosslinking agent reacts with a surface functional group of the membrane and the linker group of the surface functionalized nanoparticle. Examples of suitable crosslinking agents include 1-ethyl-3-(3-dimethylaminopropyl) carbodiimide hydrochloride (EDC), N-hydroxysulfosuccinimide (NHS), and ethylenediamine.

The surface-functionalized nanoparticles are nanoparticles that have chemically bonded groups (e.g., discrete linker groups) or polymers that have reactive functional groups. These reactive functional groups can react with reactive functional groups on the surface of the membrane. The nanoparticles are as described herein.

In an embodiment, the surface-functionalized nanoparticles have discrete linker groups. For example, the surface-modified nanoparticles can have one of the following structures:

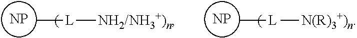

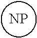

is a nanoparticle, L is a linker group, R is a C₁ to C₁₀ alkyl group and n is from 200 to 1000. The alkyl group can have one or more amine groups in the alkyl chain.

The linker group connects the nanoparticle and linker group functional group(s). Examples of suitable linker groups include, alkyl siloxane, alkyl amine, and alkyl thiol groups. For example, the linker group can have one of the following structures:

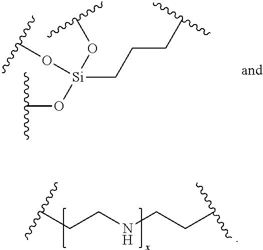

Where the linker group has an alkyl group, the alkyl group can have one or more amine groups in the alkyl chain.

In an embodiment, the surface-functionalized nanoparticle is a polymer-functionalized nanoparticle. These nanoparticles are polymer-bound nanoparticles. The polymer can have one or more functional groups that can react with and chemically bond to the membrane. The polymer can have a positively-charged group. The polymer can have one or more amine groups. The polymer can be linear or branched. An example of a suitable polymer is polyethyleneimine.

The membranes are as described herein. The membrane can be functionalized such that the membrane surface has functional groups that can react with and chemically bond to the functionalized nanoparticles. The functional groups on the membrane surface can be carboxylate groups, carbonyl groups, hydroxyl groups, amine groups, or sulfonic groups, and combinations of such groups. These groups can be in a charged form or neutral form. For example, the carboxylate group can be in a protonated form or a hydroxyl group can be in a deprotonated form (—O⁻). For example, the membrane can be functionalized by exposing the membrane to an oxygen plasma. Selection of conditions (e.g., power, frequency, gas pressure, exposure time, etc.) to provide the desired functionalization (e.g., functional group structures, density of functional groups, and location of the functional groups on the surface) is within the purview of one having skill in the art.

In an embodiment, the membrane surface has positively charged functional groups and the surface functionalized nanoparticles have functional groups that can react with the positively charged functional groups.

It is desirable the zeta potential of the membrane surface be from −60 to 0 mV, including all integer mV values and ranges therebetween. It is desirable that the zeta potential of the surface-functionalized nanoparticle be from −60 to +60 mV, including all integer mV values and ranges therebetween.

In an aspect, the present invention provides devices with nanoparticle surface-functionalized membranes. In an embodiment, a device comprises a nanoparticle surface-functionalized membrane. Examples of such devices include ultrafiltration devices, reverse osmosis (RO) devices, forward osmosis (FO) devices, pressure retarded osmosis (PRO) devices, nanofiltration (NF) devices, microfiltration (MF) devices, and membrane bioreactors (MBR).

In an aspect, the present invention provides purification of aqueous media methods using nanoparticle surface-functionalized membranes. Aqueous media include, for example, water, water-solutions, and water-containing mixtures. For example, ground water, lake or reservoir water, seawater, or waste water can be purified. In an embodiment, nanoparticle-functionalized ultrafiltration, RO, or FO membranes can be used in water purification methods.

In an embodiment, the method comprises the steps of contacting at least a portion of one surface of a nanoparticle-functionalized membrane with an aqueous medium in need of purification such the concentration of certain impurities is lowered to a desired level in the water that has passed through the membrane. The aqueous medium in need of purification can be contacted with the nanoparticle-functionalized surface of the membrane or the non-nanoparticle functionalized surface of the membrane. Accordingly, purified aqueous media has at least one component that is lowered or increased to an acceptable level.

In an embodiment, the method of aqueous medium purification includes applying pressure (either positive or negative pressure) to an aqueous medium in need of purification, the solution positioned on one side of a nanoparticle-functionalized membrane, and collecting purified aqueous medium on another side of the membrane. In another embodiment, the pressure is osmotic pressure applied using a saline solution on the opposite side of the feed solution.

Selection of the necessary conditions for contacting the membrane with the aqueous medium in need of purification is within the purview of one having skill in the art. An aqueous medium in need of purification has at least one component (e.g., chemical, biological component, suspended solid, or gas) that is desired be lowered or increased to an acceptable level (e.g., made tolerable to humans, made to meet a governmental standard, or completely removed).

The following examples are presented to illustrate the present invention. They are not intended to limiting in any manner.

### Example 1

The following is an example of preparation and characterization of a porous UF membrane of the present invention surface-functionalized with silver nanoparticles.

Described is a method for covalently or electrostatically tethering antimicrobial nanoparticles to the surface of UF membranes. Silver nanoparticles (AgNPs) encapsulated in positively charged polyethyleneimine (PEI) were reacted with an oxygen plasma modified polysulfone UF membrane with and without 1-ethyl-3-(3-dimethylaminopropyl) carbodiimide hydrochloride (EDC) present. The electron poor primary amines of the PEI react with the electron rich carboxyl groups on the UF membrane surface to form covalent and ionic bonds. The irreversible modification process imparts significant antimicrobial activity to the membrane surface. Post-synthesis functionalization methods, such as the one presented here, maximize the density of nanomaterials at the membrane surface and may provide a more efficient route for fabricating diverse array of reactive nanocomposite membranes.

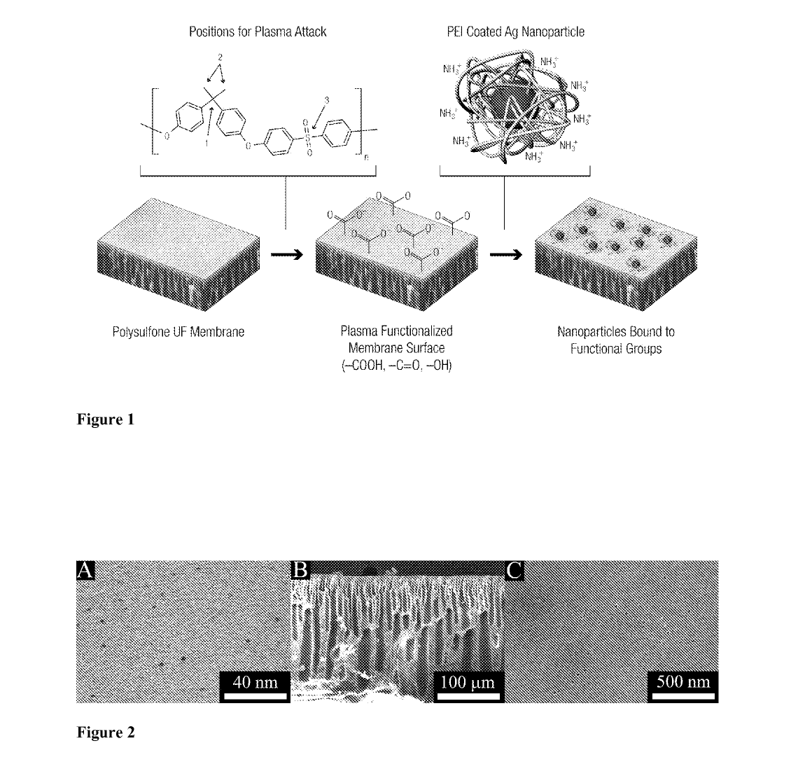

This is an example of a novel pathway for the fabrication of reactive membranes via post-synthesis grafting of nanoparticles to the membrane surface (FIG. 1). Oxygen plasma functionalizes the surface of a polysulfone ultrafiltration (UF) membrane with carbonyl, alcohol, and negatively charged carboxylic acid functionalities. Next, cationic amine-coated reactive nanoparticles are covalently and/or electrostatically bound to the functionalized membrane surface. The result is a reactive membrane that concentrates the nanoparticle activity at the membrane surface without impairing the separation properties of the membrane. The present invention reports on functionalization with biocidal silver nanoparticles, though the technique is easily adapted to a range of plasmas and nanomaterials for tailored membrane design. Simple, scalable fabrication of reactive nanomaterial membranes will expand membrane applications and improve membrane performance.

Platforms that maximize the efficiency of nanomaterial usage can reduce costs and increase performance of operational systems. For antimicrobial applications, concentration of biocidal nanomaterials at the polymer/water interface is an important step in optimizing system performance. This example demonstrates the effectiveness of surface grafting techniques for attaching biocidal AgNPs to the surface of an ultrafiltration membrane.

Thin-film composite polyamide membranes are the state-of-the-art materials for membrane-based water purification and desalination processes, which require both high rejection of contaminants and high water permeability. However, these membranes are prone to fouling when processing natural waters and wastewaters due to the inherent surface physicochemical properties of polyamide.

Membrane Casting and Characterization. Polysulfone ultrafiltration membranes using the immersion precipitation method were prepared. A casting dope of 18% polysulfone Mₙ 22,000 (Sigma Aldrich, St. Louis, Mo.) in 1-methyl-2-pyrrolidone (NMP) (Sigma Aldrich, St. Louis, Mo.) was cast at a thickness of 330 μm on a non-woven polyethylene terephthalate (PET) support layer (PET Grade 3249, Ahlstrom, Helsinki, Finland) using a doctor blade. The membrane was immediately immersed in a bath of DI water and 2% NMP. After 10 minutes the membrane was transferred to DI water and allowed to sit overnight. Membranes were stored in deionized (DI) water in the refrigerator prior to use.

Scanning electron microscopy (Hitachi SU-70, Hitachi Ltd., Tokyo, Japan) of the membrane surface and cross-section verified characteristic finger-like structures in the polysulfone support layer both before and after plasma treatment and membrane functionalization. Molecular weight cut-off (MWCO) analysis, also performed at each step of the membrane functionalization process, was adapted from previously reported methods. Briefly, each membrane was wet and compacted in a 10 mL Amicon stirred cell (Millipore, Billerica, Mass.) using a 1:1 mixture of isopropyl alcohol and DI water for 20 minutes at 30 psi (2.07 bar). Next, DI water was placed in the stirred cell and the pure water flux was recorded at 20 psi (1.38 bar). Finally, the membrane was challenged with six polyethylene oxide solutions of increasing molecular weight (4, 10, 35, 50, 95, and 203 kg mole⁻¹) prepared at a concentration of 1 g L⁻¹ (Polymer Source, Montreal, Quebec, Canada). Samples of the permeate solutions were retained for total organic carbon (TOC) analysis on a Shimadzu TOC-VCSH instrument (Shimadzu, Kyoto, Japan), and rejection (R=1−Cₚₑᵣₘₑₐₜₑ/C_{feed}) was determined by comparing the TOC of the permeate and feed solutions.

Membrane Plasma Treatment and Characterization. To functionalize the polysulfone (PSf) membranes with oxygen containing reactive moieties, the membranes were placed in a Glen 1000P plasma etching chamber (Yield Engineering Systems, Livermore, Calif.) attached to an O₂ gas stream. The oxygen plasma was generated at power of 100 W, frequency of 40-50 kHz, and pressure of 0.4-0.5 Torr. Plasma treatment times ranged from 5 seconds to 5 minutes, with the optimal treatment time determined to be 60 seconds. Contact angle measurements were performed on a VCA Optima Contact Angle instrument (AST Products, Billerica, Mass.).

The streaming potential of the membranes, a surrogate for surface charge, was measured at different stages in the membrane grafting process. The ζ potential of unmodified PSf, PEI-AgNPs coated membranes, and PEI-AgNPs coated membranes with EDC were determined from pH 2 to pH 10 (EKA, Brookhaven Instruments, Holtsville, N.Y.).

Direct measurement of surface charge density was also assessed through a dye chemisorption experiment. For porous surfaces, the dyes are capable of diffusing deeper into the membrane than relevant to surface coating by sizable nanomaterials, thereby leading to systematic error in surface charge density. Therefore, non-porous PSf surfaces were prepared as a membrane model by spin-casting a 15 weight % solution of PSf in N-methyl-2-pyrrolidone on a 1 inch square sheet of gold foil. The samples were oven dried at 60° C. for 15 minutes, resulting in a non-porous PSf surface atop the gold substrate. Half of the samples were reserved as controls, while the other half was treated with oxygen plasma for 60 seconds.

To measure the surface charge of the sample, the samples were contacted with the water soluble dye tolonium chloride. At high pH the molecule is deprotonated and the dye binds to the negatively charged functional groups on the sample surface. After thorough rinsing, the dye is eluted from the samples by a low pH solution and the absorbance of the eluate is measured at 630 nm wavelength. Specifically, the samples were placed in a bath of 0.5 mM solution of tolonium chloride and 10 mM NaCl at pH 11 for 7.5 minutes. The samples were rinsed in a large volume of pH 11 and 10 mM solution three times for 7.5 minutes each to ensure maximum removal of non-specifically bound dye molecules. Next, dye was eluted in a 200 mM NaCl solution at pH 2 for 7.5 minutes, and the absorbance was recorded on a 96 well plate microreader (SpectraMax 340PC, Molecular Devices).

PEI-Ag Nanoparticle Synthesis and Characterization. Positively charged silver nanoparticles were prepared in a three-step process. First, 5 mM AgNO₃ solution was mixed with an equal volume of 5 mM poly(ethyleneimine) (M_{w}=2000 g mol⁻¹). Second, NaBH₄ was added to a final concentration of 250 mM and the solution was allowed to stir for 4-5 days. Finally, the solution was dialyzed to remove excess reactants, and a solution of PEI coated Ag nanoparticles (PEI-AgNPs) was prepared for further analysis. The sizes of the PEI-AgNPs were characterized via transmission electron microscopy (FEITecnai F20, Hillsboro, Oreg.) and dynamic light scattering (ALV-5000, Langen, Germany). Electrophoretic mobility was determined using a zeta-potential analyzer (Malvern Zetasizer Nano-ZS, Worcestershire, UK) and tests were performed in DI water with an ionic conductance of 50 μS cm⁻¹ and pH 5.3. All chemicals were purchased from Aldrich (St. Louis, Mo.).

Membrane Functionalization and XPS Analysis Immediately after 30 seconds of oxygen plasma treatment, the active side of the plasma treated membrane was incubated in contact with the PEI-AgNPs solution for 4 hours. After thorough rinsing and drying, XPS was performed on the membrane samples to verify silver deposition. Membrane functionalization is visually apparent through the slight yellowing of the membrane surface upon reaction with the PEI-AgNPs. X-ray photoelectron spectroscopy (XPS) confirmed the presence of AgNPs on the membrane surface (Surface Science Instruments model SSX-100; monochromated Aluminum K-alpha x-rays with 1486.6 eV energy).

Attenuated Total Reflectance Fourier Transform Infrared Spectroscopy (ATR-FTIR). ATR-FTIR analysis was performed on a Nicolet Smart iTRTM iZ10 (Thermo Scientific, Madison, Wis.). To reduce the background signal of unmodified surfaces in ATR-FTIR analysis, a Si wafer was spin-coated with 18% PSf solution in NMP. The coated wafers were subsequently plasma treated, reacted with PEI-AgNPs, or reacted with PEI-AgNPs in the presence of EDC.

Antimicrobial Activity Testing. To assess inactivation of bacteria by PEI-AgNP functionalized membranes, the number of viable cells present on a control membrane against the quantity of viable cells present on the PEI-AgNPs functionalized membrane were compared. Specifically, kanamycin resistant Escherichia coli K12 grew overnight in 1% mannose minimal media solution. The cells were rinsed of the concentrated mannose growth media and resuspended in 10 mL of M63 minimal media containing 0.01% mannose. The active side of the membrane was placed in contact with the cell suspension for one hour at 37° C. After incubation, the membranes were rinsed with M63 solution and gently sonicated them in PBS for 7 minutes to detach deposited bacteria from the membrane surface. Finally, serial dilutions of the resulting cell suspensions were plated over six orders of magnitude on Luria Broth agar with kanamycin and counted the colonies after 24 hours of growth. All samples were performed in triplicate and inactivation rates were determined by comparing the cell density of the modified membranes in comparison to the control membrane. M63 solutions contained 20 mM KH₂PO₄, 15 mM KOH, 3 mM (NH₄)₂SO₄. For liquid media, 1 mM MgSO₄ and 3.9 μM FeSO₄— were added to M63.

Silver Release Experiments. The silver ion release was investigated from the functionalized membranes via a reservoir method. To measure the change in concentration of Ag⁺ over time, membrane specimens incubated in 20 mL of DI water on a rotating platform. The membranes were placed in a fresh vial of DI water every 24 hours. All samples were acidified by 1% HNO₃, and the concentration of silver in each vial was measured by inductively coupled plasma mass spectroscopy (Perkin Elmer Elan DRC-e ICP-MS, Waltham, Mass.). Indium and yttrium were used as internal standards for calibration of the instrument. This experiment ran for a total of 14 days.

Ag Nanoparticle Characteristics. The one step nanoparticle synthesis process yielded silver nanoparticles (AgNPs) coated in a layer of poly(ethyleneimine) (PEI), the branched product of polymerized ethyleneimine. The branched geometry creates a polymer chain with a mixture of primary, secondary, and tertiary amines in an approximate ratio of 1:2:1. The pKa of the primary amine is estimated to be near 5.5, while the secondary amine pKa is between 8 and 10. In DI water, the PEI is highly protonated and imparts a positive charge to the PEI-AgNP. The ζ-potential of the PEI-AgNPs was determined to be +54.4 mV at pH 5.3 and 50 μS cm⁻¹ ionic conductance.

Nanoparticle size was assessed through two techniques. Dynamic light scattering (DLS) measurements at 90° provide the hydrodynamic radius of the entire PEI-AgNP and revealed an Rₕ of 3.7 nm. Transmission electron microscopy, which visualized the dense AgNP but not the PEI coating, revealed an average AgNP diameter of 2.19 (FIG. 2A). Literature on antimicrobial activity of AgNPs suggests that bacterial inactivation is maximized when the particle diameter is less than 5 nm.

The hydrodynamic radius of the PEI-AgNPs was also measured for particles after exposure to EDC at 1 mg/mL. No significant change in nanoparticle size was observed after 4 hours of incubation, indicating that EDC does not alter the dispersion of PEI-AgNPs.

Polymeric Membrane Properties. Exposure of UF membranes to high fouling feedstreams induces flux decline or increased pressure drop across the membrane. Antimicrobial surfaces that reduce bacterial growth on the membrane surface have the potential to improve membrane flux and extend the time between membrane cleanings or replacement. In this invention, asymmetric polysulfone (PSf) membranes were prepared through phase inversion to obtain a tight membrane skin layer and finger-like bulk morphology (FIGS. 2B and 2C). The molecular weight cut-off (MWCO) of the unmodified membrane is 50 kD and the permeability is 75 L m⁻² hour⁻¹ bar⁻¹.

PSf is an amorphous polymer commonly used in membrane fabrication. Though a versatile polymeric material, the hydrophobicity and high fouling propensity of PSf has spurred the development of surface modification procedures to enhance wettability and reduce the adsorption of hydrophobic foulants. These surface modification techniques have taken many forms, including the incorporation of polymer blends, chemical modification of the membrane surface, graft polymerization, and plasma treatment. PSf surface modification was achieved by grafting reactive nanoparticles to a plasma activated surface.

Surface Activation by O₂ Plasma. Plasma treatment is a simple, effective, and scalable means of adding functional groups to a membrane surface. The two primary polymer transformations relevant to the present invention are chemical modification and etching. High energy components of plasma react with the polymer to form polymeric radicals. These radicals induce C—C and C—H bond cleavage, desaturation of carbon chains, and, especially in the case of oxygen plasma, addition of surface functional groups. Existing literature on the plasma oxidation of PSf has identified three preferential sites for plasma attack, with the quaternary carbon atom of the PSf backbone as the primary site (FIG. 1). Oxygen plasma treatment leads to the formation of alcohol, carbonyl, and carboxyl groups on the polymer surface, though further exposure to oxygen plasma can further oxidize these groups to CO₂ and H₂O and cause their evolution from the polymer surface.

The subsequent oxidation of surface functional groups to volatile gases can also be described as an etching process. The mass loss attributed to plasma etching is a function of polymeric structure, with fluorinated polymers generally exhibiting the greatest etching resistance. Polysulfone is notoriously susceptible to etching, with mass losses on the order of 2 mg cm⁻² seconds⁻¹ for high energy plasmas. For asymmetric membranes, this secondary effect of plasma treatment has detrimental effects on the membrane rejection if not systematically controlled.

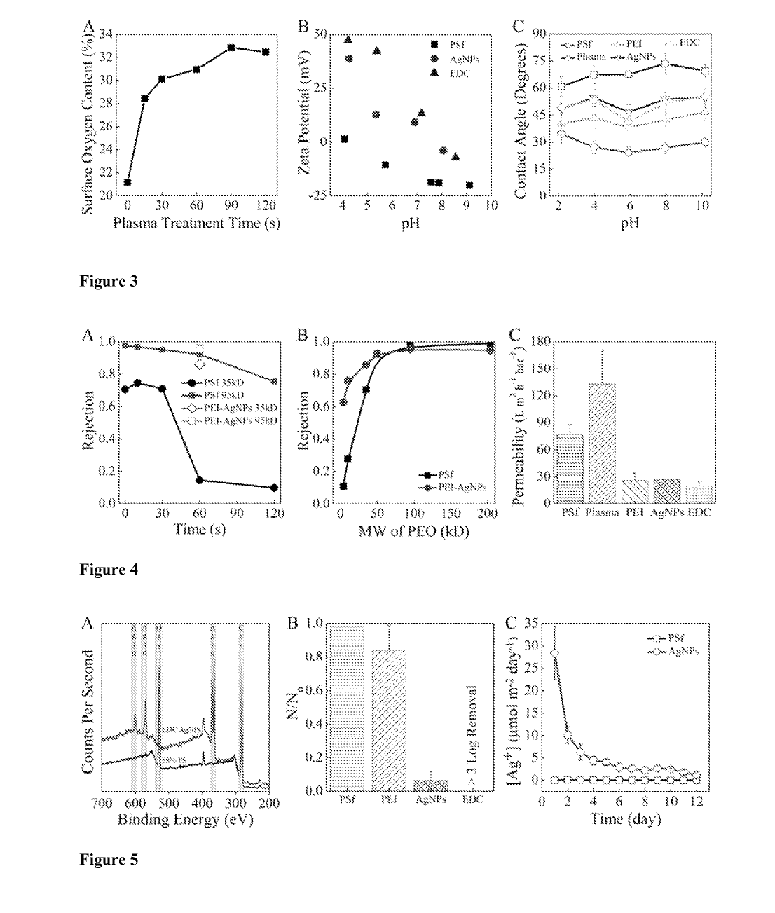

Determining Functional Group Density on the Plasma Modified Membrane. The duration of plasma treatment determines the extent of surface functionalization as well as the degree of etching. XPS analysis reveals that percentage of oxygen at the membrane surface increases with plasma treatment time but reaches a plateau between 60 and 120 seconds (FIG. 3A). While the wt % increase of oxygen between the untreated and plasma treated samples is only 12% (from 20 wt % to 32 wt %), the measurement of percent atomic concentration at the membrane surface is hindered by two factors. First, the oxygen contained in the sulfone backbone of PSf produces a strong oxygen signal that obscures the presence of oxygen functionalities on the membrane surface. Second, the sampling depth of the XPS in the polymeric material is greater than the penetration depth of the plasma. Therefore, increased oxygen content resulting from plasma treatment at the membrane surface may be muted by signal from the unmodified PSf that lies below the functionalized surface layer.

In addition to direct surface measurement, the present invention assesses functional group addition through three indirect techniques. First, the potential of the modified surfaces, or the electrical potential at the electrokinetic plane of shear, was assessed in streaming potential measurements of the membrane surface over a range of pH. The unmodified PSf membrane was neutral at low pH and negatively charged above pH 4 (FIG. 3B). As expected, modified membranes (AgNPs and EDC) were positively charged over the range of pH tested.

The transient nature of functional groups on the plasma treated surface of PSf required a separate experimental technique for determining surface charge of the PSf immediately following 60 seconds of plasma treatment. The density of negative charges (surface charge/nm²) on the membrane surface was assessed in a tolonium chloride (TBO) dye adsorption experiment. At high pH (>10) the negatively charged functionalities on the membrane surface bind positively charged TBO molecules. After thorough rinsing to reduce non-specific binding, the dye is eluted in acidic solution. The experiments indicate a 63% increase in the density of negative charges on the PSf surface after plasma treatment, with 6.9 charged functional groups per nm² for unmodified PSf and 11.3 per nm² for the plasma treated membrane (FIG. 7).

Finally, the contact angle of the native PSf surface to that of the plasma treated surface was compared. The addition of oxygen functionalities on the membrane surface increases the polar component of the surface energy and facilitates wettability (FIG. 3C). At pH 5.9, the contact angle decreased from 68° to 24°. The membrane also retains hydrophilicity after grafting of PEI and PEI-AgNPs, though this is in large part due to the hydrophilicity of the amine-rich PEI rather than the persistence of oxygen functionalities on the membrane surface or in the membrane pores.

The experimental results obtained in these indirect experiments corroborate experimental data on the plasma treatment of PSf. The presence of additional oxygen functionalities (hydroxyl, carboxyl, and carbonyl groups) increases the polar component of the surface energy. This molecular change is manifested in the bulk as increased wettability, increased negative ζ-potential at pH>3.5, decreased contact angle, and increased flux after plasma treatment.

Plasma Treatment Optimization for Preservation of Membrane Separation Properties. As previously discussed, the duration of plasma treatment also determines the degree of polymer etching. In asymmetric ultrafiltration membranes, the pore size at the skin layer determines the membrane molecular weight cut off (MWCO). Extensive etching of the membrane surface is hypothesized to remove the uppermost portion of this skin layer and decrease membrane rejection. This is illustrated in FIG. 4A, where increasing plasma treatment time reduces membrane solute rejection. There appears to be a threshold time between 30 and 60 seconds where severe loss of rejection commences. This may correspond to the onset of etching and more significant mass losses, though mass loss was not measured in the experiments. All subsequent membrane modification experiments were performed with 60 seconds of plasma treatment, which maximized surface density of surface functional groups (FIG. 3A) without severely compromising membrane rejection properties. At 60 seconds of plasma treatment, the rejection of low MW PEO (35 kD) was reduced by 85%, whereas the rejection of high MW PEO (95 kD) decreased by only 5% (FIG. 4A).

Nanomaterial Grafting to the Functionalized Membrane Surface. The post-synthesis surface modification scheme developed in the present invention utilizes O₂ plasma to activate the membrane surface with carboxylic acid, carbonyl, and alcohol functional groups. These functional groups are subsequently reacted with the PEI coated AgNPs to form electrostatic and covalent bonds that secure nanoparticles to the membrane surface, as previously described in FIG. 1.

When the anionic PSf surface is contacted with a suspension of highly cationic PEI or PEI-AgNPs, a layer of cationic polymer coats the membrane surface. In general, the anionic and cationic polymers will form multiple electrostatic bonds along the polymeric backbone, thereby allowing the assembly of a smooth monolayer that bridges defects and inconsistencies in the surface charge of the supporting layer. The effectiveness of electrostatic coating is evident from the ζ potential result. By contacting the negatively charged PSf surface with positively charged PEI, the ζ potential of the membrane transitioned from negative to positive.

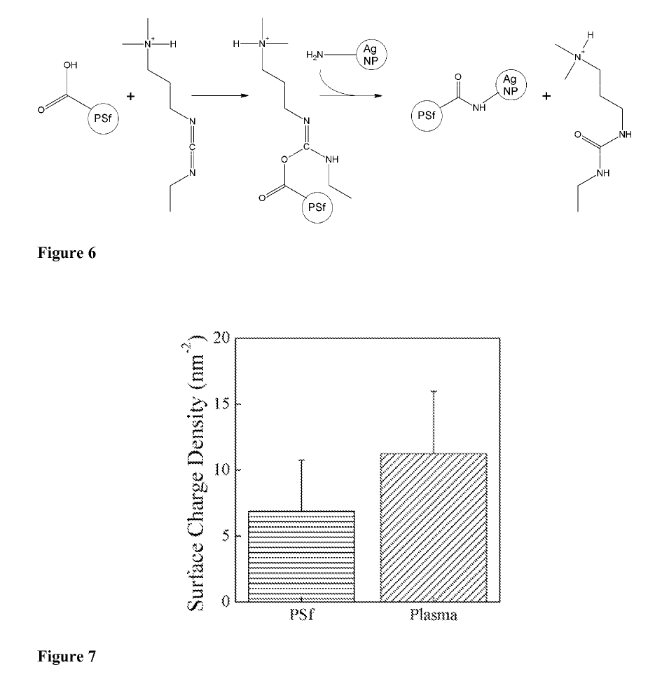

In addition to the electrostatic interactions between anionic and cationic polymer chains, the addition of carboxyl functional groups to the PSf membrane surface opens the possibility for covalent tethering to the amine groups present on the PEI-AgNPs. The formation of covalent bonds is facilitated through the addition of a crosslinking agent 1-ethyl-3-(3-dimethylaminopropyl) carbodiimide hydrochloride (EDC). EDC reacts with carboxyl functionalities to form an amine-reactive O-acylisourea intermediate. This intermediate reacts with primary amines on the PEI coated AgNP, yielding a stable amide bond and an isourea by-product. If the intermediate does not react with an amine, it hydrolyzes and the carboxyl group is restored (FIG. 6).

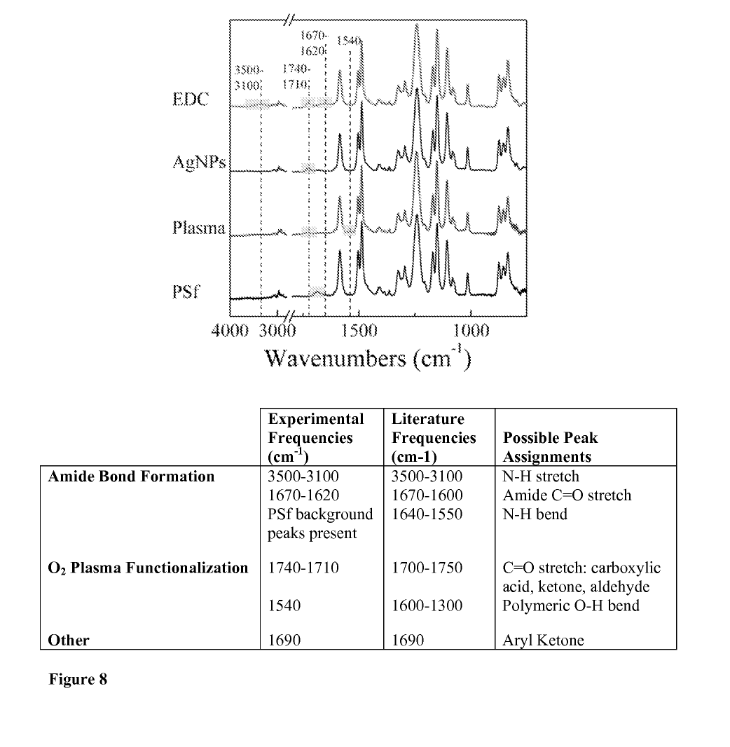

The relative importance of electrostatic interactions and covalent bonds to the stability of the grafted nanoparticles is a point of continuing investigation. The attenuated total reflectance Fourier transform infrared (ATR-FTIR) spectra of PEI-AgNPs coated polymer samples incubated in the presence of EDC have characteristic amide peaks at 3500-3100 wavenumbers (N-H stretching) and 1670-1620 (C═O stretching). PSf surfaces with electrostatically adsorbed PEI-AgNPs do not contain these peaks (FIG. 8). ATR-FTIR spectra also support the addition of carbonyl and carboxyl functionalities after plasma treatment (FIG. 8).

Membrane Properties after Surface Grafting. Ultrafiltration membrane performance is closely linked to properties of the skin layer. The membranes were re-evaluated for rejection and permeability to ensure continued membrane performance after grafting of the PEI-AgNPs. Interestingly, much of the selectivity that was lost during plasma treatment was restored upon nanoparticle grafting (FIGS. 4A and 4B). The rejection of 35 kD PEO solutes was increased from 15% to 85% while the rejection of 95 kD solutes increased from 92% to 96%. Careful observation also shows that the low molecular weight solutes (<50 kD) are rejected at a higher rate in the PEI-AgNP membrane than in the unmodified polysulfone membrane. One possible explanation is that the attachment of PEI-AgNPs to the interior of the pore walls near the surface of the membrane decreases the pore diameter, an effect that would be more dramatic in smaller pores. For reference, the hydrated radius of a 35 kD polyethylene oxide chain is approximately 6 nm and the hydrated radius of the 95 kD chain is approximately 11 nm. A single AgNP (2 nm in diameter) is insufficiently large to block membrane pores, but the 3.7 nm diameter PEI coated nanoparticle could have an appreciable effect on rejection and flux.

The presence of AgNPs on the membrane surface was verified through X-ray photoelectron spectroscopy (FIG. 5A). Silver accounted for 1.5% of the atomic concentration when EDC was not present to facilitate amide bond formation and 5.2% of the atomic concentration when EDC was present. Quantitative evaluation of surface coverage is obscured by the penetration depth of XPS (˜10 nm) relative to the diameter of the AgNPs (˜2 nm), but the trend toward higher surface coverage in the presence of EDC is significant.

Antimicrobial Functionality of Membrane Surface. The ultimate goal of post-fabrication grafting is to confer novel functionality to the membrane surface through attachment of nanoparticles. The biocidal properties and mechanism of action for AgNPs are well documented in the literature. Briefly, AgNPs are hypothesized to exert stress on bacterial cells through three interconnected pathways. The first pathway is the destabilization of the cellular membrane induced by direct incorporation of the AgNPs into the cell membrane and the subsequent formation of permeable pits disrupting the proton motive force. The second pathway is the slow dissolution of AgNPs into Ag⁺ ions and their interference with the transport and respiratory enzymes in the external cell membrane. Ions denature the ribosome and hinder ATP production by suppressing the expression of enzymes and proteins essential to the glucose pathway and Krebs cycle. The final pathway is linked to the formation of reactive oxygen species when a cell's respiratory activity is decoupled from the proton motive force and an insufficient number of terminal oxygen receptors are present on the interior of the cell membrane. Although some debate exists in the literature, DNA damage by silver nanoparticles has not been conclusively demonstrated as a primary mechanism of action for AgNP toxicity.

A number of studies have linked the physiochemical properties of silver nanoparticles to their antimicrobial activity and proteomic response in laboratory and environmental systems. Nanoparticle size appears to be a primary determinant of NP toxicity, with smaller particles (<5 nm diameter) exhibiting greater antimicrobial activity than larger particles. It was previously hypothesized that the curvature of smaller NPs facilitates mass transfer and higher rates of Ag⁺ ion release.

The release of Ag⁺ ions and residual ion concentration is a crucial aspect of the efficacy of NPs in inactivating bacteria. Although the antimicrobial mechanism of Ag ions and Ag NPs are indistinguishable, Ag NPs exhibit potency at lower concentrations than Ag ions. This enhanced toxicity is due to the potency of silver ions released from the nanoparticles combined with nanoparticles themselves interacting with the cells.

Antimicrobial activity assays of the AgNP grafted membrane surfaces quantified cellular inactivation and demonstrated the efficacy of the present system in conveying the biocidal properties of the nanomaterials to the membrane surface. One hour incubation tests (FIG. 5B) with E. coli K12 concentrations of 10⁶ cells/mL achieve bacterial inactivation rates of over 94%.

Linear cationic polyelectrolytes, including ammonium polybases such as PEI, also exhibit antimicrobial properties toward E. coli. To differentiate between the biocidal properties of the positively charged PEI and the antimicrobial activity of the silver nanoparticles, inactivation experiments on plasma treated membranes coated with pure PEI were simultaneously performed. The PEI inactivates 16% of the cells within one hour, but for long term toxicity experiments (>3 hours), the toxicity effect of PEI is significantly reduced as a layer of cells coats the surface of the membrane.

Ag⁺ Ion Release Rate. The long term efficacy of nanoparticle grafted membranes depends on the durability of nanomaterials attachment to membrane surface and the preservation of nanomaterial activity. For antimicrobial surfaces, the functionality of the nanomaterial is dependent on the mechanism of antimicrobial activity. For contact-dependent antimicrobial agents (e.g., single walled carbon nanotubes), the functionality depends on the clearing of cellular matter upon cell inactivation and an environment free of other surface foulants. For nanomaterials that act through dissolution or release of a secondary agent, the functionality is coupled to the initial loading of the antimicrobial agent and the release rate. This relationship between loading and release has strong analogs in the field of drug delivery, where loading and release are critical to pharmaceutical efficacy. Tailored design of the nanomaterial coating for efficient grafting, controlled release, and high loading (or regenerative ability) is a next step in the design of nanomaterial grafted membranes.

The membranes fabricated here displayed initial ion release rates of 28.4 μmoles m⁻² day⁻¹ that declined steadily with time (FIG. 5C). The membranes with EDC facilitated grafting released significantly higher concentrations of silver ion at the start of the experiment (110.2 μmoles m⁻² day⁻¹), but after 14 days the Ag⁺ concentration was similar to that of the membranes where EDC was not used to catalyze carboxyl-amide linkages (data not shown).

1-ethyl-3-(3-dimethylaminopropyl) carbodiimide hydrochloride (EDC) facilitated reaction (FIG. 6); surface charge density of unmodified polysulfone (PSf) membrane and the PSf membrane after 60 seconds oxygen plasma treatment (FIG. 7); attenuated total reflectance Fourier transform infrared spectroscopy (ATR-FTIR) of PSf thin-film during the modification process (FIG. 8).

### Example 2

The following is an example of characterization of a thin-film composite polyamide membrane of the present invention surface-functionalized with silver nanoparticles.

This example describes antifouling membranes for water purification. The approach is based on deposition of various nanoparticles onto the surface of various polymer membranes.

Antimicrobial nanoparticles impart biocidal properties to polyamide membrane and control their biofouling. This example describes a method to permanently tether nanoparticles by exploiting the native functional groups of polyamide. Controlling the surface density and uniform distribution of the nanoparticles coating is important to concentrate the nanoparticle activity at the membrane surface.

These hybrid organic-inorganic membranes (i.e., surface functionalized membranes) can prevent performance loss due to biofouling. This example describes modified RO/FO thin-film composite (TFC) membranes fabricated by immobilizing nanoparticles to the surface of the membrane. Silver nanoparticles surface-modified with polyethylene imine were synthesized. The surface modification renders the particles positively charged facilitating their immobilization onto the polymer surface, which contains negatively charged groups. The presence of such negatively charged groups is optimized during polymerization. Silver nanoparticles were chosen because of their well-known antimicrobial activity.

Membranes coated with reactive nanoparticles offer a number of advantages over their mixed-matrix membrane counterparts. The primary benefit is in the concentration of nanoparticles at the membrane surface where reaction occurs. Secondary benefits include manufacturing scalability, the range of membrane and nanomaterial functionalization options, and reduced cost stemming from more efficient utilization of the reactive nanoparticles.

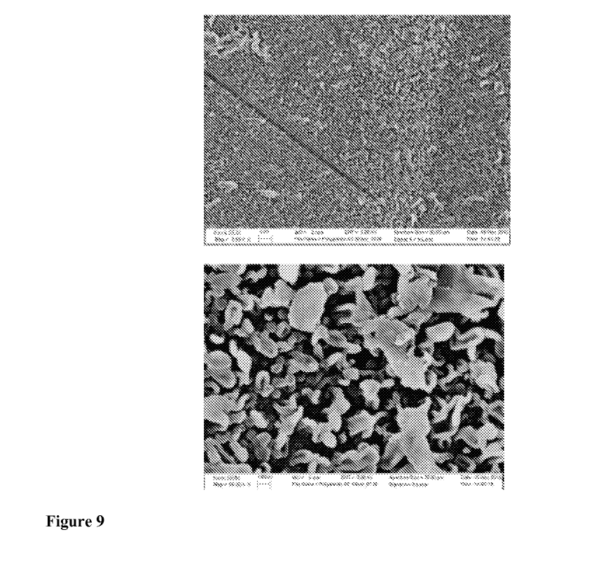

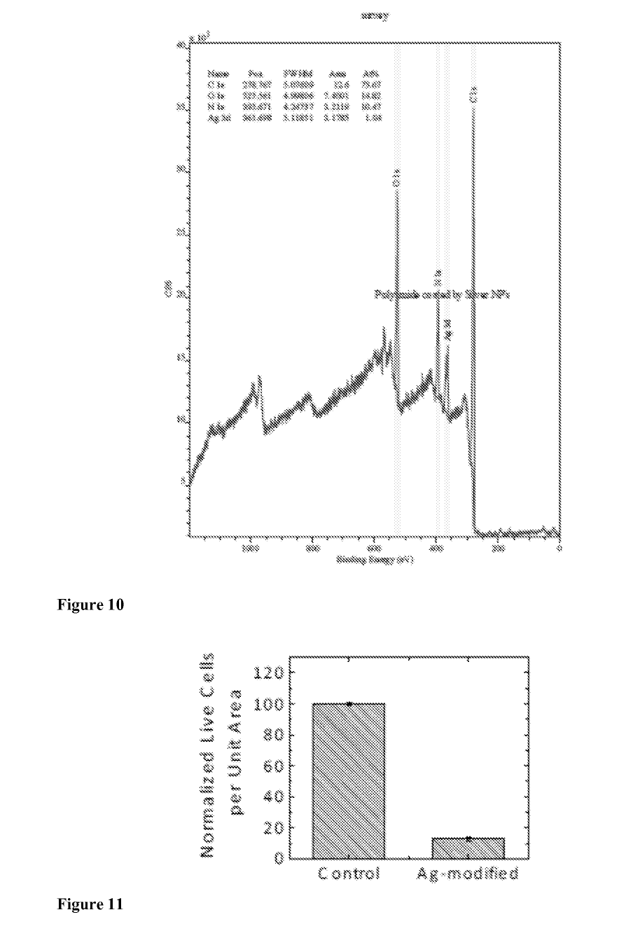

The treatment leads to uniform, durable coatings (FIG. 9). XPS studies confirm the presence of silver on the surface of the treated membrane (FIG. 10). Coating with the nanoparticles lowers the contact angle from ˜70° to 30°. The nanoparticles are strongly bound to the polymer and remain immobilized after the modified membranes are subjected to sonication, high pressure drop, and strongly acidic or alkaline environments.

The membrane surfaces modified with silver nanoparticles show enhanced antibacterial properties in comparison with the unmodified polyamide membrane (FIG. 11). Tests were carried out by contacting E. coli bacterial cells (˜10⁸ cell/mL) with the membrane active layer for 1 hour in isotonic solution (0.9% NaCl) at 27° C. Following the contacting period the cells were resuspended using sonication and the resulting solution was plated in order to count colony-forming units.

The silver nanoparticle treated membrane shows about 90% efficacy compared to the control. At the same time, the salt rejection rate and permeability of the membrane remained virtually unchanged. These membranes are expected to show a delayed onset of biofouling when employed in crossflow modules, thus maximizing productivity per unit membrane area, minimizing water flux decline, and helping in reducing plant size to decrease capital costs.

Ultrafiltration membranes perform critical pre-treatment functions in advanced membrane treatment processes. However, during operation, biofouling substantially increases both membrane resistance and the energy demands of water treatment. To circumvent this problem surface modification of the membranes using silver nanoparticles has been the primary focus. In this case the polysulfone membrane was oxygen plasma treated first to generate anchoring groups on the polymer surface to electrostatically bind the nanoparticles. Molecular weight cutoff studies suggest that the optimum treatment is 30 sec. Performance evaluation of the membranes revealed up to 95% inactivation of E. coli after one hour of incubation with the membrane.

### Example 3

The following is an example of preparation and characterization of a thin-film composite polyamide membrane of the present invention surface-functionalized with silica nanoparticles.

In this example, the fouling behavior and the fouling resistance of superhydrophilic thin-film composite forward osmosis membranes that were functionalized with surface-tailored nanoparticles is described. Fouling experiments in both forward osmosis and reverse osmosis configuration were performed using alginate, bovine serum albumin, and Suwannee river natural organic matter, chosen as model organic foulants. A synthetic solution simulating the chemistry of wastewater effluents was employed. Reduced fouling was observed for superhydrophilic membranes compared to control polyamide membranes. The fouling resistance and cleaning efficiency of the functionalized membranes was particularly outstanding in forward osmosis. The intermolecular forces between foulants and membrane surfaces were measured using atomic force microscopy. Lower adhesion forces were observed when the superhydrophilic membranes were used. The antifouling properties of superhydrophilic membranes stem from the barrier provided by tightly bound hydration layer at their surface, as well as from the neutralization of carboxyl groups of initial polyamide membranes.

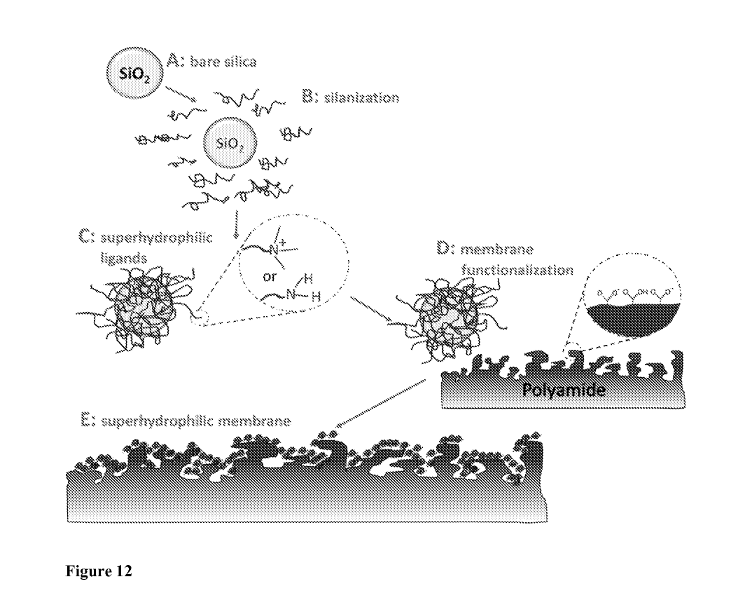

The present invention demonstrates the fabrication of superhydrophilic thin-film composite polyamide forward osmosis membranes by surface functionalization with tailored nanoparticles. The proposed surface functionalization procedure is remarkably simple and effective, and follows the steps illustrated in FIG. 12. Silica nanoparticles (Step A) are surface-coated with superhydrophilic cationic ligands (Step B) to create a stable nanoparticle suspension. The ligands are terminated with either quaternary ammonium or amine functional groups (Step C), to stabilize the nanoparticles and to provide anchor sites for tethering the nanoparticles to the membranes. A dip-coating protocol is performed during which the nanoparticles strongly bind to the native carboxyls of hand-cast polyamide FO membranes (Step D). The newly fabricated surfaces (Step E) are extensively characterized and their physicochemical properties as well as their interfacial energies are investigated. The new superhydrophilic membranes have the potential to significantly improve membrane performance by reducing and delaying fouling.

Properties of the Nanoparticles are Fine-Tuned for Membrane Functionalization. Silica nanoparticles were used because their surface chemistry can be readily fine-tuned, thereby facilitating the attainment of target hydrophilic properties and enabling control of the interaction with the membrane surface. Two different ligands were employed to functionalize the nanoparticle surface. Nanoparticles treated with N-trimethoxysilylpropyl-N,N,N-trimethylammonium chloride carry quaternary ammonium groups and are hereafter designated as —N(CH₃)₃⁺ nanoparticles. The second treatment using (3-aminopropyl)trimethoxysilane produced nanoparticles with amine surface functionalities that are henceforth referred to as —NH₂/NH₃⁺ nanoparticles.

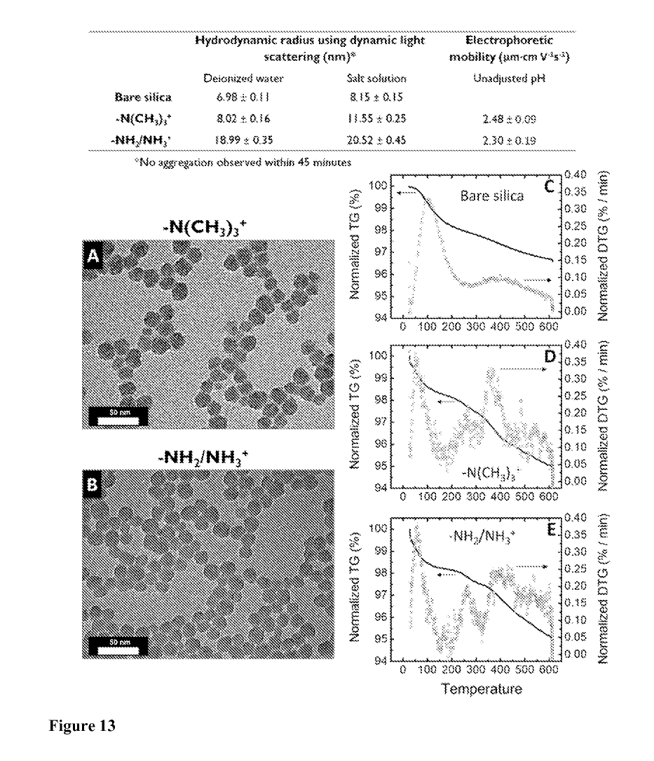

Upon surface functionalization, the presence of ammonium or amine groups rendered the functionalized nanoparticles positively charged, as confirmed by measurements of their electrophoretic mobility (FIG. 13). The charge of —N(CH₃)₃⁺ nanoparticles is not significantly affected by solution pH, while the charging behavior of the —NH₂/NH₃⁺ nanoparticles is dependent on solution pH through protonation/deprotonation.

The starting bare silica nanoparticles had a hydrodynamic radius of approximately 7 nm as observed by DLS measurements. The measured radius in deionized (DI) water increased to ˜8 and ˜19 nm for the —N(CH₃)₃⁺ and —NH₂/NH₃⁺ functionalizations, respectively (FIG. 13, table). While the small increase in diameter for the quarternary ammonium-functionalized nanoparticles is attributed to the presence of a hydration layer bound to the hydrophilic surface ligands, the increase in size of the amine nanoparticles was likely due to slight aggregation. TEM imaging showed that the size of both types of functionalized nanoparticles was comparable to that of the bare silica nanoparticles. This observation substantiates the hypothesis that the —NH₂/NH₃⁺ nanoparticles undergo aggregation in aqueous solution. No change in diameter was observed by DLS within 45 minutes of measurement for both functionalized nanoparticle types, suggesting that aggregation occurred immediately upon dispersion of the particle in solution. Overall, the positively-charged surface groups increased the electrostatic repulsion between functionalized nanoparticles, thwarting their aggregation in aqueous solution.

In the presence of electrolytes in solution, DLS data demonstrated an increase in hydrodynamic size for all nanoparticles (FIG. 13, table). This phenomenon can be due to slight aggregation and/or to the adsorption of highly hydrated multivalent counterions onto the charged and hydrophilic particle surface. This mechanism could further enhance the structuring of the water molecules at the solid-liquid interface, resulting in a larger measured hydrodynamic diameter by DLS.

The presence of organic ligands on the surface of the functionalized nanoparticles was confirmed by TGA measurement (FIG. 13C-D-E). TGA data showed the appearance and amplification of two thermal degradation peaks (˜250 and ˜400° C.) for the functionalized nanoparticles. These peaks may be associated with thermo-oxidation of the alkyl chains of the surface ligands and possibly to the volatilization of some excess coupling agents used during particle functionalization. The production of a larger amount of volatile degradation products translated into a smaller percentage of sample recovery at the end of the heating cycle compared to the bare silica nanoparticles.

Nanoparticles are Irreversible Bound to the Membrane Surface after Functionalization. Polyamide membranes fabricated via interfacial polymerization of TMC and MPD possess an outer layer of relatively high, negative fixed charges resulting from incomplete reaction and hydrolysis of the TMC acyl chlorides into carboxyls. The surface density of carboxylic groups of the membranes used in this invention was measured by TBO 19±4 charges/nm² of planar area. The positively charged groups at the nanoparticle surface ensure durable adhesion to the membrane surface via strong interaction with the native polyamide moieties, thus securing the nanoparticles at this interface. Specifically, the membrane-particle tethering occurred here primarily via electrostatic attraction. In addition, the functionalization with —NH₂/NH₃⁺ nanoparticles was performed in the presence of crosslinking agents EDC and NHS to facilitate the formation of covalent amide bonds between the nanoparticle amine groups and the membrane carboxyls. The functionalized membranes are hereafter designated as —N(CH₃)₃⁺ or —NH₂/NH₃⁺ membranes.

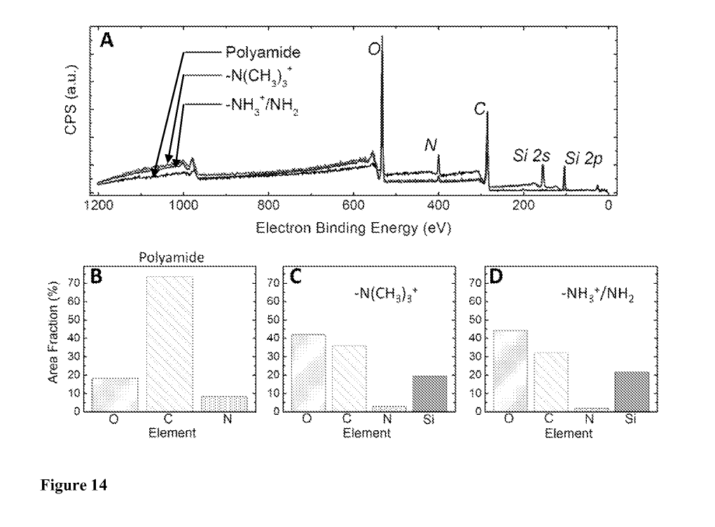

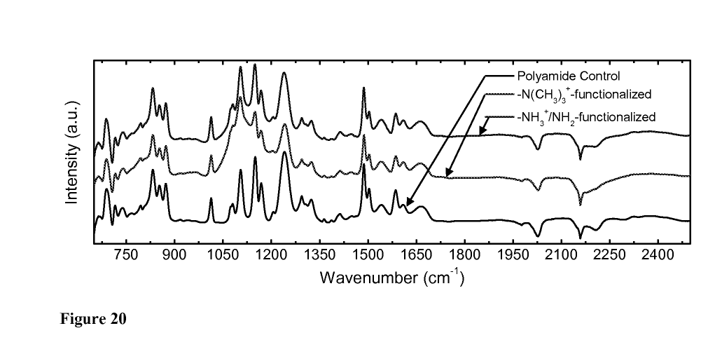

Presence of Nanoparticles at the Surface. XPS data of the membrane surfaces evaluated before and after functionalization are presented in FIG. 14. The energy peaks observed for the polyamide surface are attributed to carbon, oxygen, and nitrogen (FIG. 14A) among which carbon was the most abundant element (FIG. 14B), consistent with the chemistry of the membrane active layer. The spectra related to the functionalized surfaces showed the appearance of energy peaks associated with silicon (FIG. 14A), which confirm the presence of the silica-based nanoparticles at these surfaces. Because XPS analyzes only the superficial portion of the membrane, oxygen was observed to be the predominant element, followed by carbon and silicon (FIG. 14C-D), according to the composition of the functionalized silica nanomaterial. ATR-IR spectra showed the emergence of a shoulder and an increase in absorbance around 1060-1100 cm⁻¹ (FIG. 20), which is attributed to the stretching mode of Si—O—Si bonds. This observation further confirms the presence of silanized SiO₂ nanoparticles at the membrane surface.

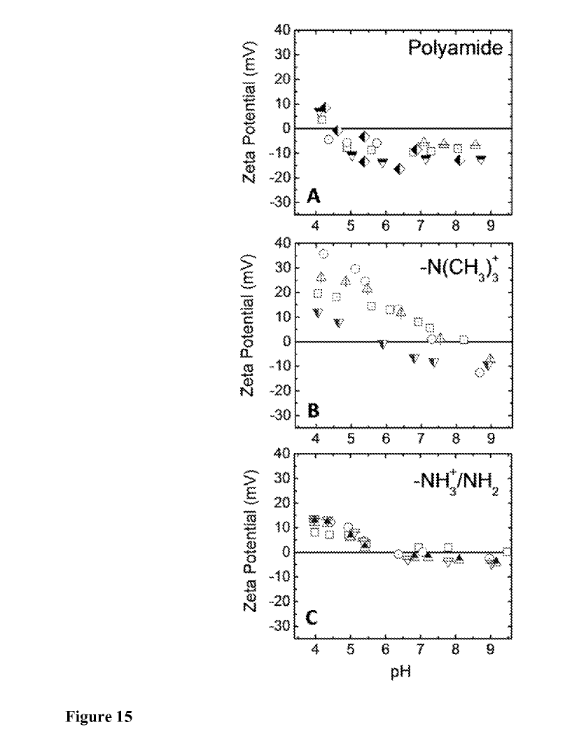

Surface Zeta Potential. FIG. 15 presents the pH-dependent zeta potential of the membrane surfaces before and after functionalization. The zeta potential was measured over the pH range of 4-9 for at least four separately cast and functionalized membrane samples. Knowledge of the membrane surface zeta potential and of the type and density of exposed charges is crucial because these parameters greatly influence the membrane fouling behavior.

The results with the control membranes were in accordance with the protonation behavior of polyamide functional groups. At very low pH, the unreacted amine groups of MPD are protonated while carboxylic groups are uncharged, resulting in an overall positive potential (FIG. 15A). As the pH increased above the pKₐ of the polyamide carboxyl groups, these predominant acidic groups deprotonated, thus imparting a negative and largely constant zeta potential to the surface.

The zeta potential behavior of the functionalized membranes was consistent with the functionalities present at both the nanoparticle and the membrane surface. The —N(CH₃)₃⁺ nanoparticles are positively charged at all pH values and interact with the membrane carboxylic moieties via electrostatic attraction. Therefore, the zeta potential of the membranes was highly positive at low pH, where carboxyl groups are uncharged, and became progressively more negative as the carboxylic groups deprotonated (FIG. 15B). The overall zeta potential was close to zero around the pH range of 7-8, which is the characteristic pH of natural waters and wastewater effluents in membrane separation processes.

Nanoparticles functionalized with —NH₂/NH₃⁺ ligands are assumed to preferentially form amide bonds with the membrane carboxylic groups, thus effectively neutralizing many of the charges present on both reacting surfaces. As a result, the measured values of zeta potential of the —NH₂/NH₃⁺ membranes were of lower magnitude compared to those of the —N(CH₃)₃⁺ membranes and exhibited a wider near-zero potential region, between approximately pH 6 and 8 (FIG. 15C). The zeta potential results provide an indirect evidence for the presence of nanoparticles at the surface of the functionalized membranes and of the type of particle-membrane interaction.

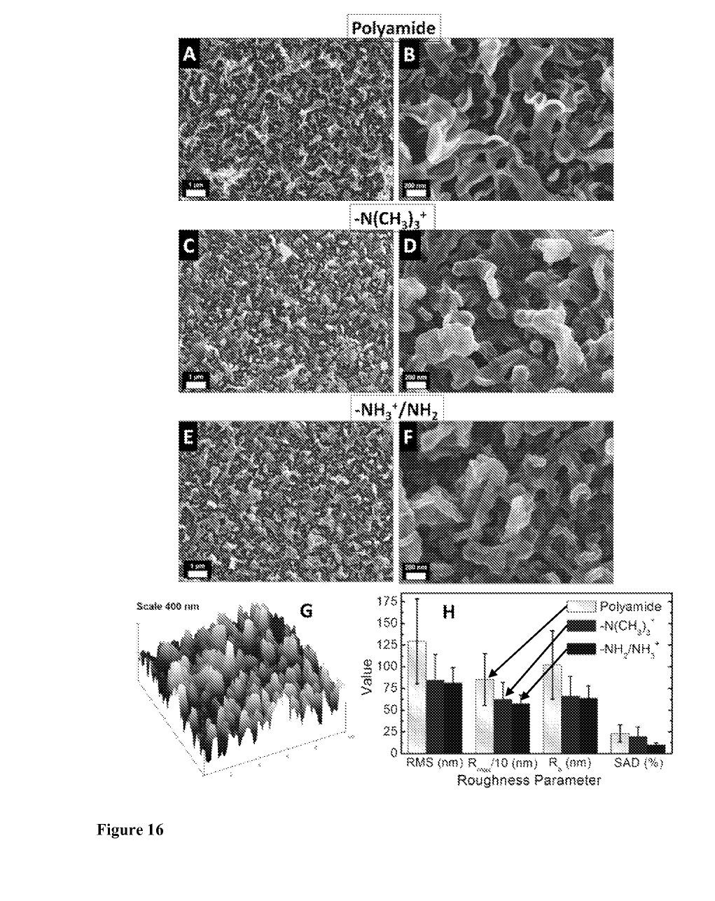

Surface Roughness and Morphology. The membrane surface morphology before and after functionalization was analyzed by SEM and AFM (FIG. 16). The representative topographic image (FIG. 16G) and SEM surface micrographs (FIG. 16A-B) of a control polyamide membrane showed a uniform ridge-and-valley morphology, which is typical of polyamide thin films formed by interfacial condensation. The characteristic surface roughness parameters of the membranes were measured by tapping mode AFM. The untreated polyamide surfaces had a RMS of 129±40 nm, an average roughness, Rₐ, of 102±39 nm, a maximum roughness, Rₘₐₓ, of 850±30 nm, and a surface area difference, SAD, of 23±10% (FIG. 16H). These values are comparable to those reported for similar materials.

The high magnification SEM micrographs in FIG. 16D-F, imaged at the surface of the membranes after functionalization, showed that the ridge-and-valley features of the functionalized surfaces were overlain by a layer of nanoparticles. The nanoparticle size correlates well with the radius measured by DLS experiments for each respective type of surface functionality. The low magnification SEM micrographs presented in FIG. 16C-E suggest that the overall morphology of the membrane surface was not significantly affected after functionalization, as the ridge-and-valley features were visible and comparable to those observed for the control polyamide surface. This observation suggests that the nanoparticle layer was thin relative to the membrane active layer.

The surface roughness measurements of functionalized membranes (FIG. 16H) indicated a reduction in surface roughness due to the presence of nanoparticles, although it was not sufficient to alter the overall surface morphology, consistent with SEM analysis. The nanoparticles are likely to deposit preferentially within the valley-like regions of the polyamide surface, thus flattening the overall surface. This flattening was more pronounced for the relatively larger —NH₂/NH₃⁺ nanoparticles, which produced a more significant effect in decreasing the membrane SAD (FIG. 16H and Table 1).

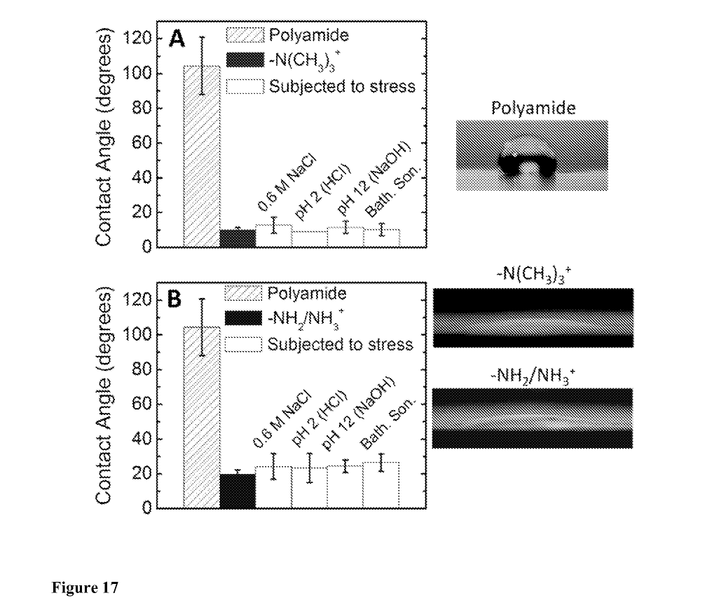

Nanoparticles Render the Membrane Superhydrophilic. Contact Angles and Irreversibility of Functionalization. FIG. 17 presents the average contact angles of DI water at the surface of control (polyamide) and functionalized membranes before (solid bar) and after (hollow bars) they were subjected to chemical and physical stresses. The untreated polyamide membranes had a relatively large contact angle of 104±16°, partly due to their roughness (FIG. 17 and Table 1). The digital picture (FIG. 17A) shows a representative profile of a water droplet on the hydrophobic polyamide surface. The presence of nanoparticles on the surface functionalized membranes had a dramatic effect on the conformation of water droplets at the solid-liquid interface, yielding contact angles of ˜10° for the —N(CH₃)₃⁺ membranes and ˜20° for the —NH₂/NH₃⁺ membranes (Table 1). Representative pictures of water droplet profiles for the two functionalized surfaces are presented on the right of FIG. 17B.

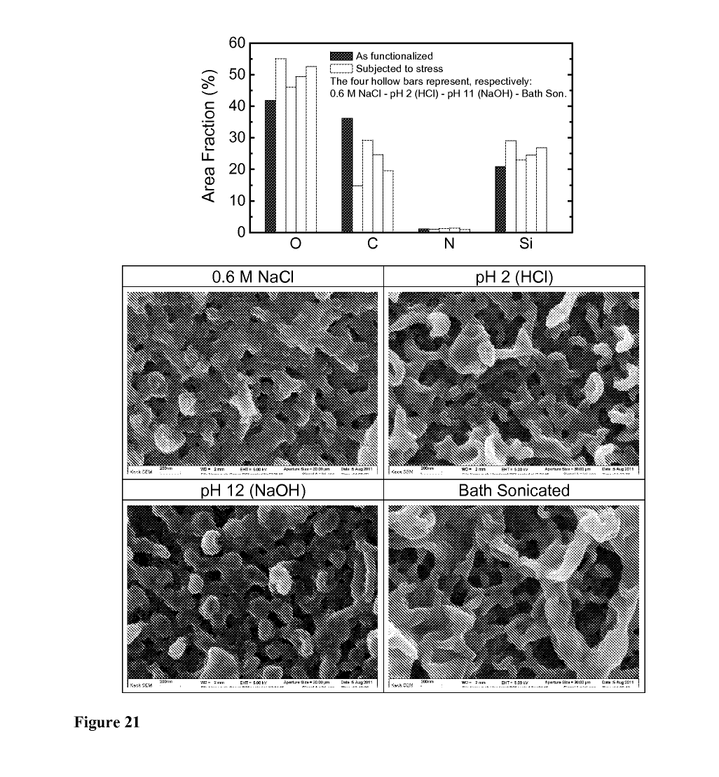

Contact angle measurements were also used as a proxy to appraise the reversibility of the interaction between nanoparticles and membrane surfaces. Chemical or physical stresses considerably harsher than typical operational conditions were applied to the functionalized membranes and the conformation of water droplets was then re-evaluated. The contact angles did not significantly change compared to membranes analyzed immediately after modification (FIG. 17A-B), suggesting that the nanoparticle-membrane bonds were sufficiently strong to render the surface functionalization irreversible. XPS and SEM analyses were also performed subsequent to the stress protocol and showed no significant difference compared to the results obtained on the functionalized membranes not subjected to stresses (FIG. 21).

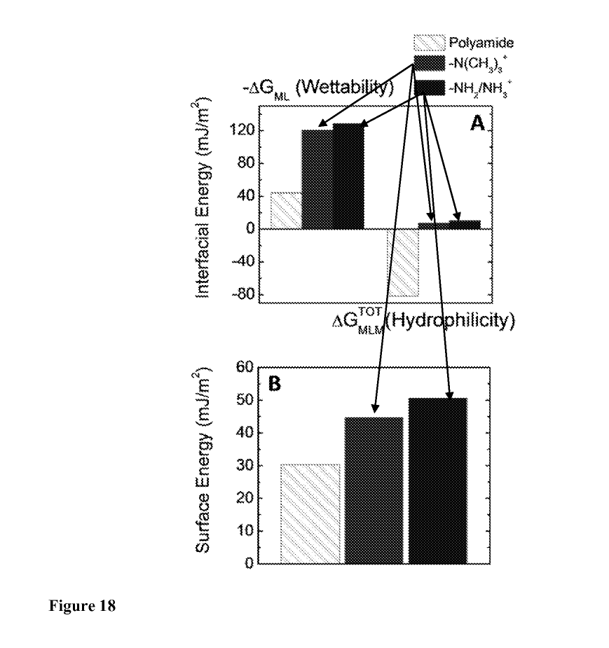

Membrane Surface and Interfacial Energies. The surface tensions and interfacial free energies of the membranes were calculated from contact angle measurements with two polar liquids, water and glycerol, and an apolar liquid, diiodomethane (Table 1). The polyamide control membrane had a low surface energy (γ^{TOT}=30.0 mJ/m²), almost exclusively resulting from van der Waals forces. As a result, the polyamide surface was found to be relatively wetting (−ΔG_{ML}=44.3 mJ/m²) but hydrophobic (ΔG_{MLM}=−81.7 mJ/m²) when immersed in deionized water (FIG. 18).

The surface properties of the membranes changed dramatically after functionalization with superhydrophilic nanoparticles. Both the Lifshitz-van der Waals and the acid-base components of surface tensions increased. In particular, the electron donor parameter was responsible for the nearly monopolar functionality of the surface (Table 1), consistent with the properties of the ligands coating the nanoparticle surface. The high density of electron donor sites at the surface of the functionalized membranes promotes hydrogen bonding interactions with water molecules. This, in turn, resulted in a significant increase in calculated membrane wettability and in a conversion of the surface interfacial free energy of cohesion to positive values, i.e., hydrophilic properties (FIG. 18A). The high interfacial free energy was accompanied by a relatively large value of surface energy (FIG. 18B). The strong hydration layer of the superhydrophilic surface resists the adsorption of molecules and particles to the membrane surface, thus increasing its anti-fouling resistance.

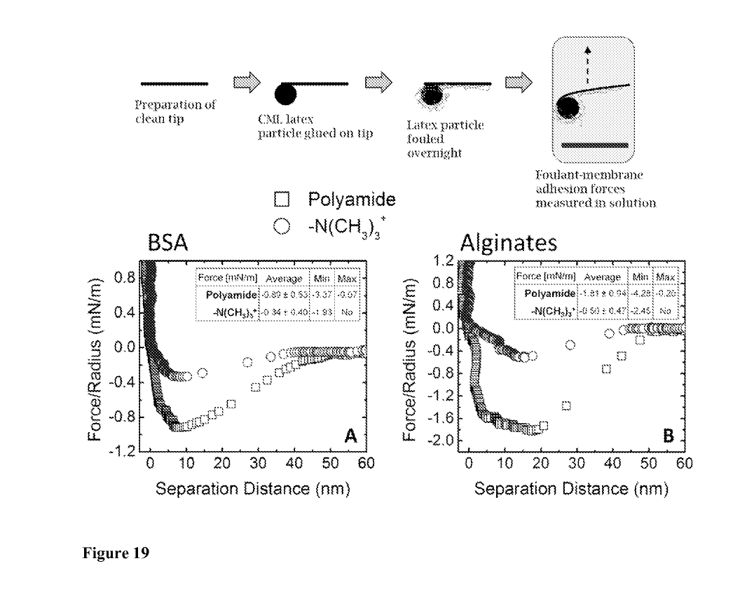

Superhydrophilic Membranes Have Lower Interaction Forces with Organic Foulants. The rationale for creating superhydrophilic membranes for water separation technologies is to impart fouling resistance. By maximizing the interfacial acid-base forces between surfaces and the adherent water, a layer of tightly-bonded water molecules that act as a short-range barrier against the adhesion of foulants was formed. Atomic force microscopy (AFM) has been applied in membrane fouling/cleaning research to quantify intermolecular forces when foulants approach the investigated surface within the contact limit. The interaction forces between model foulants adsorbed on a colloidal probe, namely alginate and BSA, and the membranes were investigated (FIG. 19). Representative adhesion (pull-off) curves obtained during the retraction of the fouled tip from the membrane surface are presented. The average, minimum, and maximum values of adhesion forces calculated from a statistically significant number of retracting force-distance curves analyzed in 5 randomly selected spots on each membrane sample are reported.

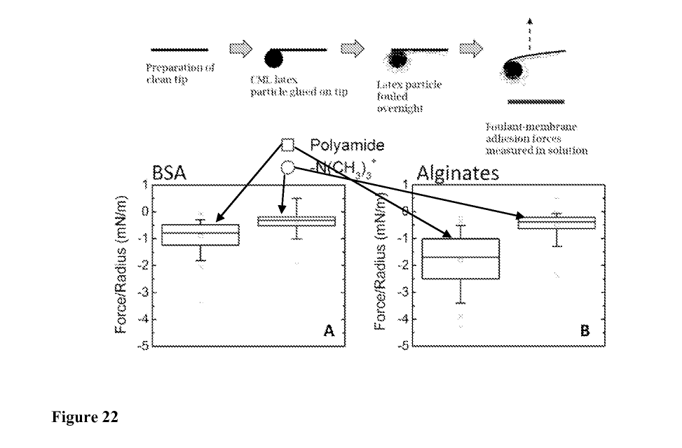

AFM results showed that the attractive energy well between model foulants and control polyamide membranes was deeper than that observed using functionalized, superhydrophilic membranes (FIG. 19A-B). The resulting distribution of foulant-membrane intermolecular forces was also statistically more negative (i.e., more attractive) for the control polyamide membranes (FIG. 22). Several force-distance curves measured on —N(CH₃)₃⁺ membranes did not show an attractive energy well but only repulsive forces, indicating no foulant adhesion to the membrane due to a barrier to adhesion. This behavior was not observed for control polyamide membranes on which all AFM foulant probe engagements resulted in an attractive force, often exceeding −3 mN/m for both foulant molecules. These results are consistent with observations showing lower attractive forces on hydrophilic surfaces, and indicate the attainment of superhydrophilic surfaces with potentially lower fouling propensity.

Conclusions. Forward osmosis membranes with superhydrophilic surface properties that could significantly reduce fouling were fabricated. The surface of silica nanoparticles was functionalized with superhydrophilic ligands possessing quaternary ammonium or amine moieties. A simple dip-coating technique was utilized to irreversibly bind the nanoparticles to the native carboxylic groups of polyamide forward osmosis membranes. The functionalization produced a uniform layer of nanoparticles on the polyamide film rendering the membrane surface highly wettable and superhydrophilic. Using atomic force microscopy, significantly lower adhesion forces between model organic foulants and the superhydrophilic surfaces compared to unmodified polyamide membranes were measured. These observations are significant because lower foulant-membrane adhesion has been shown to correlate well with increased membrane fouling resistance.

Experimental.

Fabrication of the Membranes and Characterization of their Transport Properties:

TFC membranes were prepared by interfacial polymerization of polyamide onto hand-cast support membranes. The support membranes were fabricated by nonsolvent (water) induced phase separation of a solution of 9 wt % polysulfone (PSf, Mₙ: 22,000 Da) dissolved in N-N-dimethylformamide (DMF, anhydrous, 99.8%). The polyamide active layer was then formed on top of the PSf support membranes via reaction between 1,3-phenylenediamine (MPD, >99%) and 1,3,5-benzenetricarbonyl trichloride (TMC, 98%) dissolved in Isopar-G (Univar, Redmond, Wash.).

Fabrication and Characterization of the Superhydrophilic Nanoparticles:

Superhydrophilic nanoparticles were fabricated by surface functionalization of silica nanoparticles (Ludox HS-30, 30%, Sigma Aldrich) with two different ligands (FIG. 12, steps A-B-C). In the first instance, 6 g of silica nanoparticles were dispersed in 30 mL of deionized water and the suspension was sonicated for 30 minutes. The obtained dispersion was vigorously stirred with freshly prepared silane solution containing 2.1 g of (3-aminopropyl)trimethoxysilane (—NH₃⁺/NH₂, 97%, Sigma-Aldrich 281778) dissolved in 24 mL of water. For the second functionalization, 6 g of silica nanoparticles were suspended in 54 mL of deionized water and sonicated for 30 minutes. Then, 6.4 g of N-trimethoxysilylpropyl-N,N,N-trimethylammonium chloride (—N(CH₃)₃⁺, 50 wt %, Gelest SIT8415.0) were added to the dispersion under vigorous stirring. Both procedures were followed by pH adjustment to ˜5 and a heating step to 60° C. for 18 hr. Finally, the suspensions were dialyzed in deionized water using SnakeSkin tubing (7 k MWCO, Pierce) for 48 hours.

Dynamic light scattering (DLS) experiments were performed to determine the effective hydrodynamic diameters of the functionalized nanoparticles using a multi-detector light scattering unit (ALV-5000, Langen, Germany). The electrophoretic mobility of the particles was determined by a Zetasizer Nano-Z (Malvern Instruments, Worcestershire, U.K.) in deionized water at three different pH values of 5, 6, and 7. For thermogravimetric analysis (TGA) (Exstar TG/DTA 6200, Seiko Instruments Inc., Torrance, Calif.), the nanoparticle solution was freeze-dried and TGA was performed from 40 to 600° C. at a heating rate of 20° C./minute. Transmission Electron Microscopy (TEM) micrographs of the nanoparticles were acquired using a Tecnai T12 apparatus operating at 120 keV (FEI, Eindhoven, The Netherlands).

Membrane Functionalization and Characterization:

The density of carboxyl functional groups at the surface of polyamide membranes was evaluated by binding and elution of toluidine blue O dye (TBO). Carboxyl moieties were exploited to irreversibly bind the functionalized silica nanoparticles to the membranes, following a simple dip coating protocol (FIG. 12, steps D-E). Briefly, the polyamide membranes were immersed into the nanoparticle suspension for 16 hr at room temperature (23° C.), with only the membrane active layer side accessible for contact with the suspension. The pH of the suspensions was adjusted to 6.4-7.4 before the dip coating step. In the case of membrane functionalization with nanoparticles coated with amine-terminated ligands, the tethering procedure was preceded by contact of the polyamide layer with a solution of ˜2 mM N-(3-dimethylaminopropyl)-N′-ethylcarbodiimide hydrochloride (EDC, 98%) and ˜5 mM N-hydroxysuccinimide (NHS, 98%) for 15 minutes. The polyamide surface treatment with EDC and NHS converts the native carboxylate groups of the polyamide surface into intermediate amine-reactive esters for crosslinking with the amine functional groups at the nanoparticle surface.

The elemental composition of the membrane surface was analyzed by x-ray photoelectron spectroscopy (XPS, SSX-100 UHV, Surface Science Instruments). The sample was irradiated with a beam of monochromatic Al K-alpha X-rays with energy of 1.486 keV. Attenuated Total Reflectance (ATR-IR, ThermoScientific Nicolet 6700) was performed using a germanium crystal on desiccator-dried samples. Membrane surface morphology was investigated by scanning electron microscopy (SEM, LEO 1550 FESEM). Before imaging, membranes were sputter coated with a layer of carbon (BTT-IV, Denton Vacuum LLC, Moorestown, N.J.). Membrane surface roughness was analyzed using a Multimode AFM (Veeco Metrology Group, Santa Barbara, Calif.) in tapping mode. Symmetric silicon probes with 30-nm-thick back side aluminum coating were employed (Tap300A, Bruker Nano Inc, Camarillo, Calif.). The probe had a spring constant of 40 N/m, resonance frequency of 300 kHz, tip radius of 8±4 nm, and cantilever length of 125±10 μm. Air-dried membranes were scanned in air at 12 randomly selected scan positions.

Surface wettability was evaluated from contact angle measurements of deionized water using the sessile drop method (VCA Video Contact Angle System, AST Products, Billerica, Mass.). The system is equipped with software to determine the left and right contact angles (VCA Optima XE). To account for variations between different measurements on the same surface, at least four desiccator-dried samples from separately cast and functionalized membranes were tested on a minimum of six random locations, and the data were averaged. The relative wettability of the membranes was evaluated by calculating the membrane-liquid interfacial free energy as

$$- Δ {G}_{ML} = {γ}_{L} ( 1 + \frac{cos θ}{SAD} ) ,$$

where θ is the average contact angle and γ_{L} is the pure water surface tension (72.8 mJ/m² at 25° C.). Contact angles of deionized water were also used as a proxy to confirm the irreversibility of the nanoparticle-membrane bonds with functionalized membrane surfaces, after these were subjected to chemical or physical stress. Chemical stress was applied by contacting the functionalized surfaces for 15 minutes with a pH 2 solution (HCl), a pH 12 solution (NaOH), or a 0.6 M NaCl solution approximating the ionic strength of typical seawater, followed by thorough rinse with deionized water. Physical stress was exerted by immersing the membranes in a sonicating water bath (Fisher Scientific F60) for 7 minutes. XPS spectra and SEM images were also re-evaluated after each of these steps to confirm the presence and extent of particle functionalization and assess the irreversibility of the functionalization.

Additional measurements of contact angles of glycerol (≧99%) and diiodomethane (≧99%) were used to calculate the Lifshitz-van der Waals (γ^{LW}), electron donor (γ⁻), and electron acceptor (γ⁺) components of the membrane surface tension before and after functionalization. The total surface energy of the membrane surfaces is defined as the sum of the surface tension due to Lifshitz-van der Waals and to the Lewis acid-base components, γ^{TOT}=γ^{LW}+γ^{AB}, where γ^{AB}=2\sqrt{γ⁺γ⁻}. From the membrane and the water components of the surface tension, it is possible to calculate the total interfacial free energy of cohesion of membrane interfaces immersed in water, ΔG_{MLM}(TOT), which is often termed “hydrophilicity”. A higher value of the free energy is obtained if the membrane is non-cohesive, or more hydrophilic, when immersed in water.

The zeta potential of the membrane surface before and after functionalization was measured in an asymmetric clamping cell using a streaming potential analyzer (EKA, Brookhaven Instruments, Holtsville, N.Y.). Measurements were performed with alternating flow direction of a 1 mM KCl solution, and varying the pH of the solution by adding appropriate amount of HCl or KOH. Four separately cast and functionalized membranes were evaluated. Detailed experimental procedure and the method to calculate the zeta potential from the measured streaming potential are given elsewhere.

AFM Interaction Forces:

Atomic force microscopy (AFM) was used to measure the adhesive force between representative foulants in the bulk solution and the membrane by adapting previously published procedures. The force measurements were performed in a fluid cell utilizing a particle probe, modified from a commercialized SiN AFM probe (Veeco Metrology Group, Santa Barbara, Calif.). A carboxylate modified latex (CML) particle (Interfacial Dynamics Corp., Portland, Oreg.) with a diameter of 4.0 μm was attached to the tipless SiN cantilever using Norland Optical adhesive (Norland Products, Inc., Cranbury, N.J.). The particle probe was cured under UV light for 30 min. The CML-modified probe was immersed in 2000 mg/L model organic foulant solution, namely alginate or bovine serum albumin (BSA), for at least 16 hr at 4° C. to prevent organic degradation. The AFM adhesion force measurements were performed in a fluid cell. The ionic composition of the test solutions injected into the fluid cell was representative of a typical wastewater effluent (0.45 mM KH₂PO₄, 9.20 mM NaCl, 0.61 mM MgSO₄, 0.5 NaHCO₃, 0.5 mM CaCl₂, and 0.93 mM NH₄Cl). The pH of the test solution was adjusted to 7.4 prior to injection. The membrane was equilibrated with the test solution for 30-45 minutes before force measurements were performed. The force measurements were conducted at five different locations, and at least 25 measurements were taken at each location. Data obtained from the retracting force curves were processed and converted to obtain the force versus surface-to-surface separation curves.

TABLE 1
Summary of the contact angle and surface energy data of the
different membranes analyzed in this invention. Average contact
angles of the water, glycerol, and diiodomethane are reported
(degrees), along with the different components of the surface
energy of the membrane surface, expressed in mJ/m².

| | | | | SAD | | | | | | | ΔG_{MLM} |
|---|---|---|---|---|---|---|---|---|---|---|---|
| Membrane | θ_{wat} | θ_{gly} | θ_{diod} | (%) | γ^{LW} | γ⁺ | γ⁻ | γ^{AB} | γ^{TOT} | −ΔG_{ML} | (TOT) |
| Polyamide | 105 | 76.5 | 27.2 | 12.3 | 30.0 | 0.05 | 0.79 | 0.38 | 30.4 | 44.3 | −81.7 |
| —N(CH₃)₃⁺ | <10 | 17.6 | 18.3 | 11.9 | 33.9 | 0.9 | 32.0 | 10.8 | 44.7 | 121 | +7.32 |
| —NH₃⁺/NH₂ | 19.9 | 23.7 | 25.7 | 9.9 | 38.0 | 1.1 | 35.8 | 12.6 | 50.6 | 129 | +10.4 |

Superhydrophilic nanoparticles with tailored surface functionalities were irreversibly bound to the surface of forward osmosis thin-film composite polyamide membranes. The functionalization renders the membrane surface superhydrophilic and dramatically increases its wettability with water. Reduced adhesion forces are measured between model foulants and the functionalized membrane surface compared to the unmodified control polyamide, suggesting lower organic fouling during operation.

Polyamide membranes are functionalized with super-hydrophilic silica-based nanoparticles. Contact angles of functionalized membranes with deionized water decrease dramatically compared to unmodified control polyamide membranes. The contact angle does not change significantly after subjecting the functionalized surface to chemical of physical stress, proving the irreversibility of the functionalization. Functionalization renders the polyamide surface super-hydrophilic. Roughness properties of the polyamide surface are not affected by the functionalization. Foulant-membrane interaction forces measured by AFM contact mode are substantially reduced. Functionalization significantly decreases flux loss due to membrane fouling of SRNOM and BSA organic molecules in forward osmosis.

### Example 4

The following is an example of preparation and characterization of a thin-film composite polyamide membrane of the present invention surface-functionalized with silica nanoparticles.

In this example, the fabrication of forward osmosis polyamide membranes with optimized surface properties via facile and scalable functionalization with fine-tuned nanoparticles is described. Silica nanoparticles are coated with superhydrophilic ligands possessing functional groups that impart stability to the nanoparticles and bind irreversibly to the native carboxyl moieties on the membrane selective layer. The tightly tethered layer of nanoparticles tailors the surface chemistry of the novel composite membrane without altering the morphology or water/solute permeabilities of the membrane selective layer. Surface characterization and interfacial energy analysis confirm that superhydrophilic and highly wettable membrane surfaces are successfully attained. Lower intermolecular adhesion forces are measured between the new membrane materials and model organic foulants, indicating the presence of a bound hydration layer at the polyamide membrane surface that create a barrier for foulant adhesion.

This example describes the fouling behavior and antifouling mechanisms of thin-film composite forward osmosis membranes with superhydrophilic surface properties. The active layer of hand-cast thin-film composite FO membranes is successfully functionalized with non-depleting superhydrophilic nanoparticles. This functionalization optimizes the polyamide surface chemistry and interfacial energy to reduce membrane fouling with model organic foulants, specifically alginate, bovine serum albumin (BSA), and Suwannee river natural organic matter (SRNOM). The role of hydraulic pressure in membrane fouling by comparing membrane performance in FO (without hydraulic pressure) and RO (with hydraulic pressure) modes was also studied. Finally, interfacial force measurements are used to explain the fouling behavior and identify the antifouling mechanism of the superhydrophilic membranes.

Materials and Chemicals. Polysulfone (PSf) beads (Mn: 22,000 Da), 1-methyl-2-pyrrolidinone (NMP, anhydrous, 99.5%), N-N-dimethylformamide (DMF, anhydrous, 99.8%), 1,3-phenylenediamine (MPD, >99%), and 1,3,5-benzenetricarbonyl trichloride (TMC, 98%) were used as received (Sigma-Aldrich, St. Louis, Mo.). A polyester nonwoven fabric (PET, grade 3249, Ahlstrom, Helsinki, Finland) was used as a backing layer for the PSf membrane supports. For interfacial polymerization of polyamide, TMC was dispersed in Isopar-G, a proprietary non-polar organic solvent (Univar, Redmond, Wash.). Chemicals used for post-treatment of polyamide membranes were sodium hypochlorite (NaOCl, available chlorine 10-15%, Sigma-Aldrich) and sodium bisulfate (NaHSO₃, Sigma-Aldrich). Sodium chloride (NaCl, crystals, ACS reagent) from J.T. Baker (Phillipsburg, N.J.) was used for the membrane performance tests. Unless specified, all chemicals were dissolved in deionized (DI) water obtained from a Milli-Q ultrapure water purification system (Millipore, Billerica, Mass.).

Membrane Fabrication. TFC FO membranes were fabricated via interfacial polymerization of polyamide on hand-cast polysulfone support layers. The PSf support layer was fabricated by nonsolvent induced phase separation. PSf (9 wt %) was dissolved in DMF and then stored in a desiccator for at least 15 hours prior to casting. To begin casting the membrane, the PET fabric was attached to a glass plate and wetted with NMP. The PSf solution was drawn down the PET fabric using a casting knife (Gardco, Pompano Beach, Fla.) with agate height fixed at 350 μm (˜15 mils). The whole composite was immersed in a precipitation bath containing 3 wt % DMF in DI water at room temperature to initiate phase inversion. The support membrane remained in the precipitation bath for 10 minutes before being transferred to a DI water bath for storage until polyamide formation. Polyamide thin-films were fabricated via interfacial polymerization of MPD (3.4 wt % in DI water) and TMC (0.15 wt % in Isopar-g). The fabricated TFC membranes were rinsed thoroughly and stored in DI water at 4° C.

Nanoparticle Preparation and Membrane Functionalization. Superhydrophilic nanoparticles were fabricated by surface functionalization of silica nanoparticles with a radius of approximately 7 nm (Ludox HS-30, 30%, Sigma Aldrich). Briefly, 6 g of nanoparticles were suspended in 54 mL of deionized water and sonicated for 30 minutes. Then, 6.4 g of N-trimethoxysilylpropyl-N,N,N-trimethylammonium chloride (—N(CH₃)₃⁺, 50 wt %, Gelest SIT8415.0) was added to the dispersion under vigorous stirring. This step was followed by pH adjustment to ˜5 and a heating step to 60° C. for 18 hours. Finally, the suspension was dialyzed in DI water using SnakeSkin tubing (7 k MWCO, Pierce) for 48 hours.

Free carboxyl moieties at the surface of polyamide membranes were exploited to irreversibly bind the functionalized silica nanoparticles to the membranes via a simple dip coating protocol. The polyamide membranes were immersed in the nanoparticle suspension for 16 hours at room temperature (23° C.), with only the active layer side in contact with the suspension. During this step, the positively charged ammonium groups at the surface of the nanoparticles bind to the negatively charged carboxylic groups at the surface of polyamide membranes via electrostatic attraction. The pH of the suspensions was adjusted to 6.4-7.4 before the dip coating protocol.

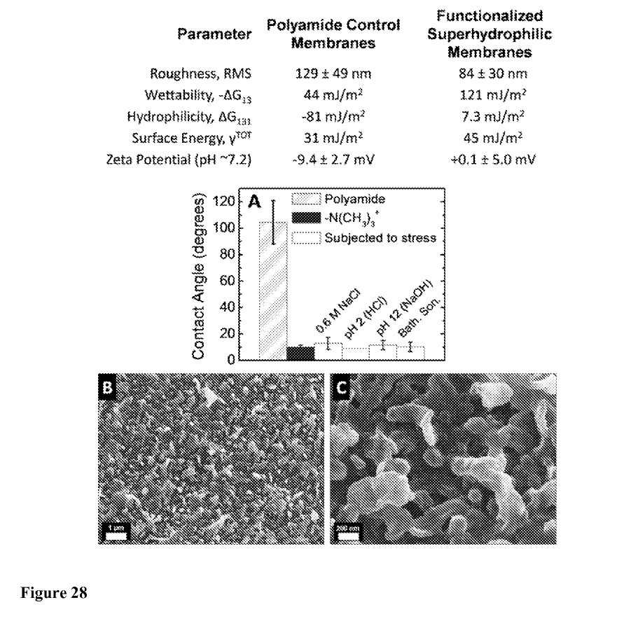

Membrane Characterization. Control and functionalized membranes were tested using a cross-flow membrane filtration system. Two sets of experiments were conducted: one in FO mode (DI water as feed solution against the membrane active layer and 1 M NaCl as draw solution) and one in pressure retarded osmosis (PRO) mode (DI water feed solution against the membrane support layer and a 0.5 M NaCl draw solution). No mesh spacers were employed and both co-current cross-flow velocities were fixed at 21.4 cm/second. The setup was maintained at a constant temperature of 25±0.5° C. Water flux in both experiments was determined by monitoring the rate of change in weight of the draw solution for 30 minutes. During the FO experiment, NaCl concentration in the feed was also monitored at 3 minute intervals with a calibrated conductivity meter (Oakton Instruments, Vernon Hills, Ill.) to quantify the reverse NaCl flux. These measurements allowed for the determination of the pure water permeability of the membrane active layer, A, the NaCl permeability of the membrane active layer, B, and the structural parameter of the membrane support layer, S, by simultaneous solution of the FO and PRO governing equations. The membrane surface physicochemical and morphological properties were extensively characterized. Further details on these characterization techniques and procedures are available in FIG. 28.

Model Foulants and Solution Chemistry. The model organic foulants chosen to represent proteins, polysaccharides, and natural organic matter were, respectively, bovine serum albumin (BSA, ≧98%, Sigma-Aldrich), sodium alginate (Sigma-Aldrich), and Suwannee river natural organic matter (SRNOM, International Humic Substances Society, St. Paul, Minn.). According to the manufacturer, the molecular weight of the BSA is about 66 kDa. BSA is reported to have an isoelectric point at pH 4.7. Sodium alginate has been widely used in membrane fouling research to represent polysaccharides that constitute a major fraction of soluble microbial products in wastewater effluent. According to the manufacturer, the alginate has a molecular weight in the range of 12-80 kDa. SRNOM has been used extensively as a model organic foulant and its characteristics can be found elsewhere. The organic foulants were received in powder form. Stock solutions for BSA and alginate (10 g/L) and for SRNOM (2 g/L, adjusted to pH 10) were prepared by dissolving the foulant in DI water. The stock solutions were stored at 4° C.

The solution chemistry for the fouling and AFM experiments was based on secondary wastewater effluent from selected wastewater treatment plants in California, as described in Table 2. The final pH of the solution was ˜7.4 and the calculated ionic strength was 15.0 mM.

TABLE 2
Composition and pH of the test feed solution simulating wastewater
effluent used for all fouling and AFM experiments.

| | Concentration | Ionic Strength |
|---|---|---|
| Solute | (mM) | (mM) |
| KH₂PO₄ | 0.45 | 0.45 |
| NaCl | 9.20 | 9.20 |
| MgSO₄ | 0.61 | 2.43 |
| NaHCO₃ | 0.50 | 0.50 |
| CaCl₂ | 0.50 | 1.50 |
| NH₄Cl | 0.94 | 0.94 |
| Sum | 12.20 | 15.02 |

| | |
|---|---|
| pH | ~7.4 |

Assessing Fouling and Cleaning Behavior. The FO and RO fouling experiments were performed with cross-flow membrane systems. A constant solution temperature of 25±0.3° C. was maintained by a water bath (Neslab, Newington, N.H.). A cross-flow velocity of 21.4 cm/second during all fouling and cleaning experiments were employed. The protocol for the FO fouling experiments comprised the following steps. First, a new membrane coupon was placed in the unit and characterized. Next, the system was thoroughly rinsed with DI water and co-current cross-flows of the DI water solutions were run for >1 hour to stabilize the system. At this point, the feed solution was replaced with the testing solution described in Table 2, and an appropriate volume of a 5 M NaCl stock solution was added to the draw solution (˜1 M NaCl) to obtain a constant water flux of 19.5±0.5 L m⁻² h⁻¹ (11.5±0.3 gal ft⁻² day⁻¹). After the flux became stable, 150 mg/L of the foulant of interest were added to the feed solution and the fouling experiment was protracted for 8 hours. The feed solution was continuously mixed using a magnetic stirrer. Water flux and solute concentration in the feed solution were recorded throughout the experiment.

Baseline experiments were conducted to quantify the flux decline due to the decrease in the osmotic driving force during the fouling experiments as the draw solution was continuously diluted by the permeate water and by the reverse diffusion of NaCl into the feed solution. The baseline experiments followed the same protocol as that for the fouling experiments except that no foulant was added to the feed solution. Knowledge of A, B, and S for each coupon and of the solute concentrations, i.e., osmotic pressures, of both the feed and draw solutions at any time during fouling, allowed us to correct for the small change in water flux associated with the loss in driving force. To confirm the reproducibility of the FO fouling and cleaning experiments, all runs were duplicated.

Cleaning experiments were conducted immediately following the FO fouling runs. Conditions for cleaning experiments were as follows: 15 mM NaCl cleaning solution, cross-flow of 21.4 cm/second, and insertion of air bubbles every 3 minutes, total duration of 15 minutes. During the cleaning step, the draw solution was also replaced by 15 mM NaCl solution, so that there was no permeate flux through the membrane. Pure water and reverse salt fluxes of the cleaned membrane were determined after the cleaning experiment to determine the flux recovery.

The protocol for RO fouling experiments comprised the following steps. The membrane was first compacted overnight with DI water under an applied pressure of 20.7 bar (300 psi). The membrane was then stabilized and equilibrated with the foulant-free testing solution described in Table 2 for approximately 2 hours. The applied pressure was adjusted in this step to obtain a permeate flux analogue to that used in the FO experiments, i.e., 19.5±0.5 L m⁻² h⁻¹ (11.5±0.3 gal ft⁻² day⁻¹). Next, 150 mg/L of foulant were added to the feed solution and the fouling experiment was continued for 8 hours at constant applied pressure and keeping the feed reservoir continuously mixed using a magnetic stirrer. At the end of the fouling run, the solution in the feed reservoir was disposed of and cleaning of the fouled membrane was performed by replacing it with a 15 mM NaCl chemical cleaning solution. At the end of the cleaning stage, the chemical cleaning solution in the reservoir was discarded, the reservoir was rinsed with DI water to flush out the residual chemical cleaning solution, and the cleaned RO membrane was subjected to the second baseline performance with the foulant-free synthetic wastewater solution to re-determine the pure water flux.

AFM Contact Mode Force Measurements. Atomic force microscopy (AFM) was used to measure the foulant-foulant and foulant-membrane interfacial forces, adapting previously published procedures. The force measurements were performed with a colloid probe, modified from a commercial AFM probe (Veeco Metrology Group, Santa Barbara, Calif.). To prepare the colloid probe, a 4.0-μm carboxyl modified latex (CML) particle (Interfacial Dynamics Corp., Portland, Oreg.) was attached to a tipless SiN cantilever using Norland Optical adhesive (Norland Products, Inc., Cranbury, N.J.). The probe was cured under UV light for 20 minutes. The colloidal probe was coated with foulants by soaking it in organic foulant solution (2000 mg/L alginate, BSA, or SRNOM) for at least 24 hours at 4° C. to prevent organic degradation. During this step, the organic molecules adsorbed on the surface of the CML latex particles.

The adhesion force measurements were performed in a fluid cell. The foulant-membrane forces were measured after injecting into the fluid cell a testing solution described in Table 2. To measure foulant-foulant intermolecular forces, 20 mg/L of organic foulant were introduced into the fluid cell and adsorbed to the membrane surface. In all cases, the membrane surface was equilibrated with the test solution for 45-60 minutes before force measurements were performed. The force measurements were conducted at five different locations, and at least 25 measurements were taken at each location to minimize inherent variability in the force data. Because the focus of this invention was on the adhesion forces, only the raw data obtained from the retracting (pull-off) force versus cantilever extension curves were processed to obtain the force versus surface-to-surface separation curves. Force, rupture distance, and attraction energy distributions were obtained. The rupture distance represents the maximum extension distance where the probe-surface interaction disappears in the process of probe retraction.

Membrane Properties. Characterization of the membrane surface following functionalization showed that a layer of tightly-bonded nanoparticles was present at the surface. The cationic nanoparticles slightly decreased the average surface roughness and increased the overall zeta potential of the surface. The functionalization effectively rendered the surface superhydrophilic, attaining values of wettability and hydrophilicity that are the highest reported so far in the literature for similar materials as those employed in this invention (FIG. 28).

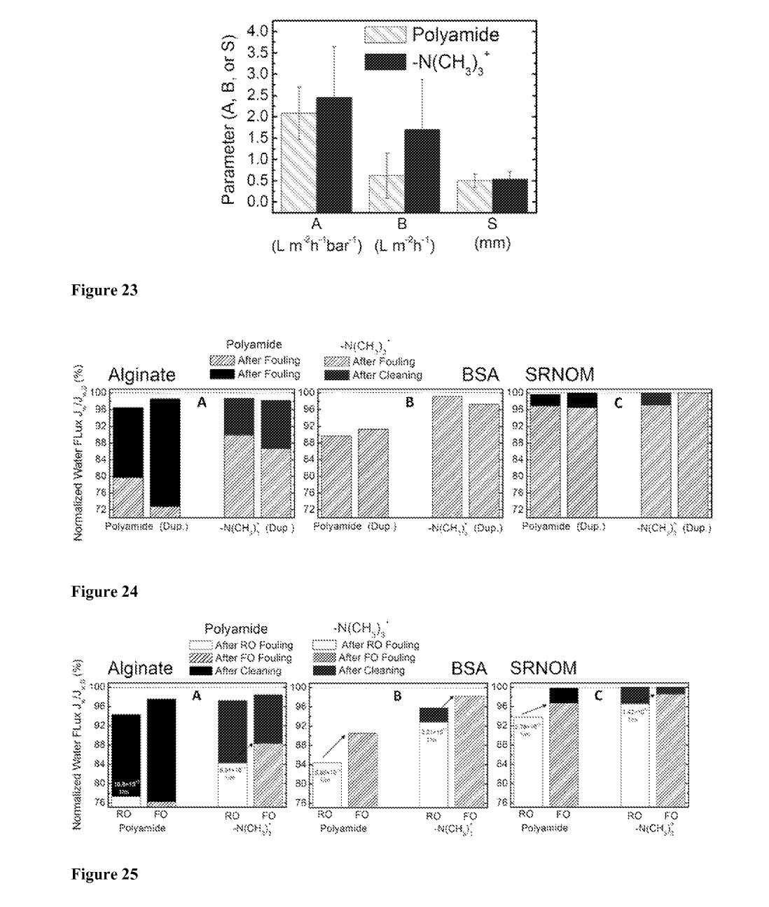

FIG. 23 presents the characteristic transport parameters for both control and superhydrophilic membranes. Average and standard deviation values of the intrinsic water permeabilities of the active layer, A, the intrinsic salt permeability of the active layer, B, and the structural parameter of the support layer, S, are shown as bars. As expected, the structural parameter of the membranes was not affected by the functionalization of the surface of the active layer. On the other hand, both A and B showed an increase. This increase is attributed to enhanced wetting of the more hydrophilic membrane surface that can result in a higher transport across the thin film, and possibly to some defects due to handling during membrane functionalization.

The combination of transport parameters resulted in an average water flux of approximately 19.5 L m⁻² h⁻¹ if the draw solution was 1 M NaCl and DI water was used as feed solution, and would produce a water flux of 8.8 L m⁻² h⁻¹ in case of 1.5 M NaCl and seawater as draw and feed solutions, respectively, based on the governing equation for FO water flux.¹² These values suggest that functionalization did not negatively affect membrane transport properties.

Organic Fouling in FO. The mechanism of fouling in forward osmosis was studied in the presence of a mixture of mono- and divalent ions and using single foulants (alginate, BSA, or SRNOM). Experiments were carried out for 8 hours and were followed by physical cleaning in the absence of calcium and with addition of air bubbles to enhance the hydrodynamic shear in the feed channel. The results of duplicate runs for control and for superhydrophilic membranes are summarized in FIG. 24 and Table 3. Pattern bars show the percentage of water flux after fouling relative to the initial flux. Solid bars present the results of relative water flux after the cleaning step. An unrealistically high concentration of foulants (150 mg/L) was used to accelerate the fouling rate. The change in water flux is heuristically related to membrane fouling and cleaning behavior.

Alginate fouling was the most pronounced, followed by BSA and SRNOM, with the latter causing little change in flux for both types of membranes. A faster decline in water flux caused by alginate fouling compared to proteins or natural organic matter was also observed. This is attributed to bridging mechanisms that solely alginate molecules experience in the presence of calcium ions, resulting in the formation of a cross-linked alginate gel layer on the membrane surface, also visually observed in this invention at the end of the runs (data now shown). This thick layer provides resistance to flux as well as accelerated cake-enhanced osmotic pressure (COEP) due to reverse salt diffusion, resulting in elevated osmotic pressure near the membrane surface on the feed side. A relatively low flux decline due to fouling by humic substances in forward osmosis was also reported recently.

TABLE 3
Summary of the FO fouling and cleaning data for the different foulants
and membranes used in this invention.

| | Foulant | | | |
|---|---|---|---|---|
| | | | —N(CH₃)₃⁺ Functionalized | |
| | Polyamide Membrane | | Membrane | |
| | | J_{w}/J_{w,0} after | | J_{w}/J_{w,0} after |
| | J_{w}/J_{w,0} after | recovery | J_{w}/J_{w,0} after | recovery |
| | fouling (%) | (%) | fouling (%) | (%) |
| Alginate | 79.7; 72.8 | 96.5; 98.6 | 90.0; 86.6 | 98.7; 98.2 |
| BSA | 89.7; 91.3 | No | 99.2; 97.3 | No |
| | | Recovery | | Recovery |
| | | Observed | | Observed |
| SRNOM | 97.2; 96.5 | 99.6; ~100 | 97.1; ~100 | ~100; ~100 |

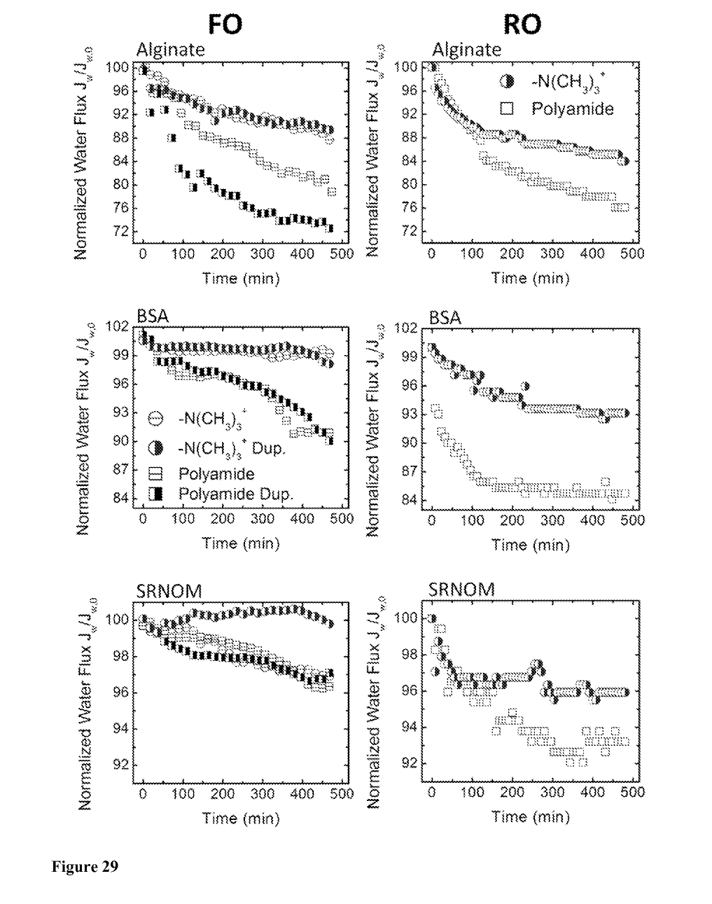

In all cases, the superhydrophilic membranes experienced a lower overall flux decline compared to control membranes. These results suggest a higher resistance to organic fouling by the functionalized membranes. This effect was very significant for alginate fouling that caused water flux losses of about half the magnitude of those experienced on the control membranes. However, the anti-fouling mechanism of the superhydrophilic surfaces was even more pronounced in the case of BSA fouling. These results confirm the anti-fouling properties of hydrophilic surfaces towards proteins, also discussed in numerous other studies. Furthermore, the decrease in water flux produced by BSA accumulation for the superhydrophilic membranes occurred within the first 50 minutes of fouling, contrary to the behavior of alginate and SRNOM, which caused a more steady decline, when present (FIG. 29). This observation suggests that fouling might have occurred due to non-functionalized patches on the surface of functionalized membranes.

The water flux was completely recovered after physical cleaning in the case of SRNOM fouling. Also, alginate fouling was found almost completely reversible despite the significant flux decline observed during the related fouling stage. The sparse and loose layer of alginate formed during fouling can be easily broken apart and removed by simple physical cleaning in the absence of calcium ions. On the contrary, no significant recovery of water flux was observed for membranes fouled by BSA.

Role of Pressure in Fouling: Comparison of FO and RO Modes. To further understand the mechanism of fouling in FO and evaluate the role of the driving force, fouling tests in both FO and RO configurations were performed. The RO fouling and cleaning data are presented in FIG. 25. An identical initial flux as that used in FO was obtained in RO by adjusting the applied pressure. Because different membranes had different permeabilities, values of the hydraulic resistance of the fouling layer are also provided, for fair comparison across the different RO tests.

In the case of BSA and SRNOM, all membrane types were fouled more in RO mode than in FO mode. This result confirms the lower susceptibility to fouling of FO performance compared to RO observed by other studies. This behavior is explained because in RO the compressible foulants form a compact and dense cake layer that increases hydraulic resistance, while foulant form a loose and sparse fouling layer on FO membranes where the sole driving force is an osmotic pressure gradient. Conversely, alginate fouling caused similar flux decline in both modes for the control polyamide membranes. Although RO is also subjected to COEP by the rejected salt, the effect is much less pronounced than with FO reverse salt diffusion where it is exacerbated by the creation of a thick alginate gel layer. Alginate fouling caused a more pronounced flux decline in RO for superhydrophilic membranes, indicating that for these membranes a significantly thinner or sparser gel layer is formed in FO.

Except in the case of RO alginate fouling of control membranes, the decrease in performance due to fouling followed the general rule: control membranes in RO>control membranes in FO≧superhydrophilic membranes in RO>superhydrophilic membranes in FO. These results confirm that the superhydrophilic membranes were also anti-fouling in RO mode. A similar sequence of performance was also found relative to the membrane cleaning efficiency. No or lower flux recovery was observed for the control polyamide membranes in RO compared to the respective FO experiments, suggesting the difficulty of removing a more compact fouling layer from the membrane surface with simple physical cleaning. On the other hand, complete recovery was found for superhydrophilic membranes fouled by SRNOM. Some flux recovery was measured also in case of BSA and alginate foulants, although not sufficient to recover the same water flux of the respective FO runs.

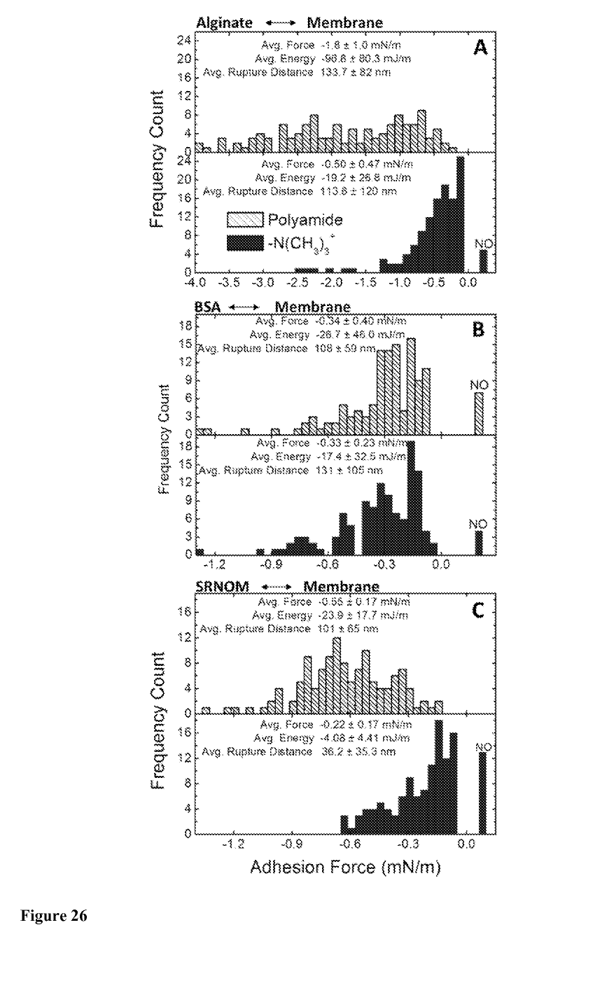

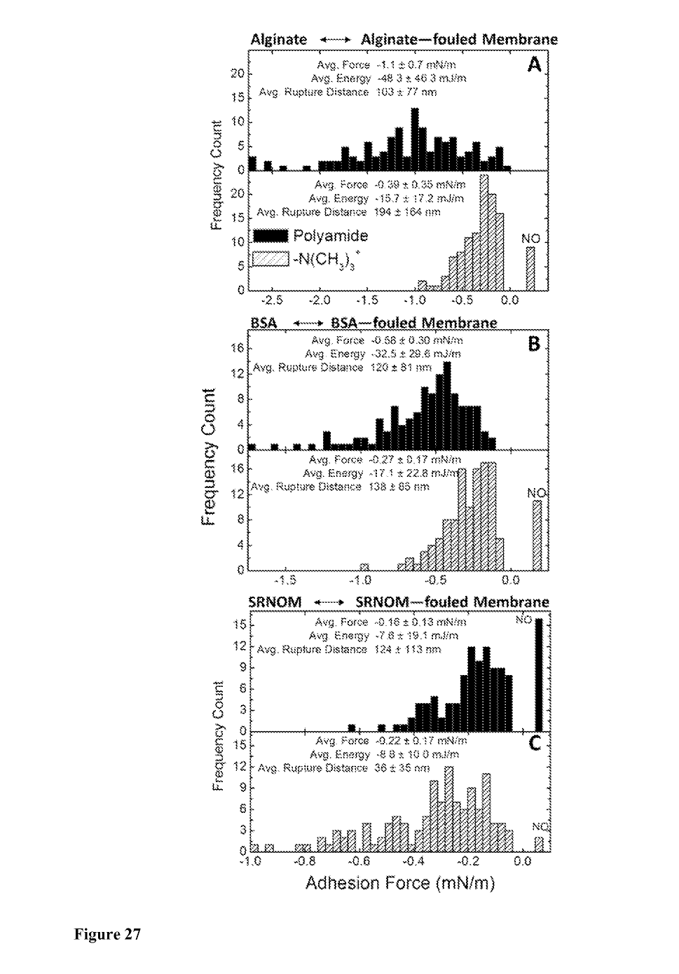

Role of Membrane Surface Properties: Interaction Forces at the Nanoscale. To explain the surface properties responsible for the different fouling behavior, AFM force measurements to characterize the foulant-membrane and foulant-foulant interactions were employed. AFM has been successfully deployed to enlighten the short-range intermolecular forces that govern the fouling behavior of surfaces. FIG. 26 and FIG. 27 present the frequency distribution of adhesion forces for foulant-membrane and foulant-foulant experiments, respectively. Foulant-membrane measurements provide information about the interaction of a clean membrane with foulants in solution and about the likelihood of initial attachment. In foulant-foulant experiments the fouled tip contacts the deposited foulants and pulls them off the surface, thus measuring the strength of adhesion of already deposited molecules on the surface. Also, the corresponding average values of adhesion force, rupture distance, and interaction energy, i.e., the work of adhesion calculated as the negative area in the force vs. distance curves were reported. Although not all the parameters are distributed normally, these averages give a first order approximation of the magnitude of surface interactions.

Comparing the force measurements with the fouling data shows direct correlation between the magnitude of the adhesion forces and that of fouling for the three organic foulants. Larger attractive interactions were measured using SRNOM, BSA, and alginate in that order, for both foulant-membrane and foulant-foulant intermolecular forces. Also, in all but few cases the adhesion force distributions measured using control polyamide membranes were skewed towards more negative values, i.e. more attractive interactions, compared to superhydrophilic membranes. Accordingly, the related average adhesion forces for the control membranes are 2 to 3 times the values calculated for the related experiments using membranes functionalized with nanoparticles. The same trend existed for the interactions measured between membranes and carboxyl-modified latex particles, often used as surrogates for carboxyl-containing molecules or bacterial cells (FIG. 33).

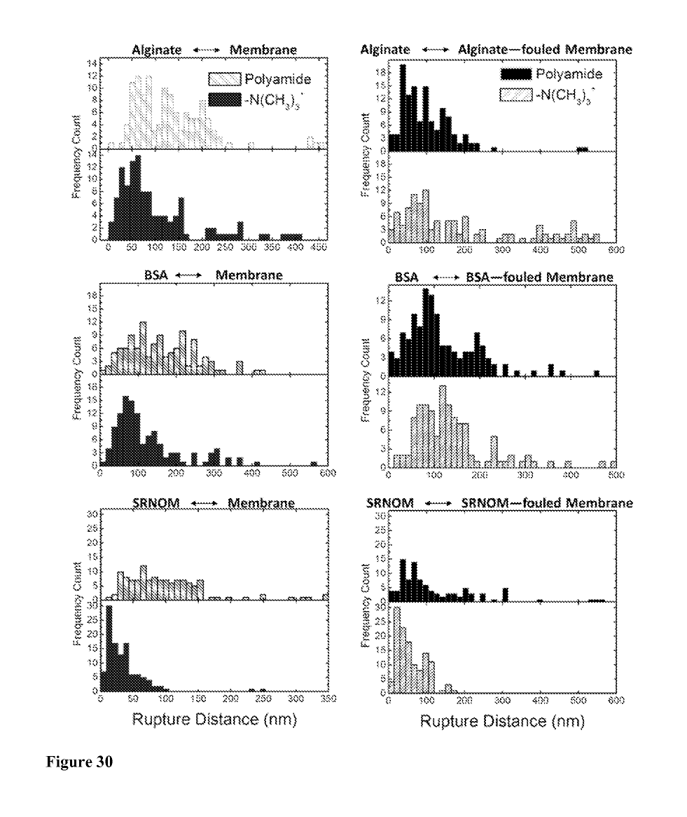

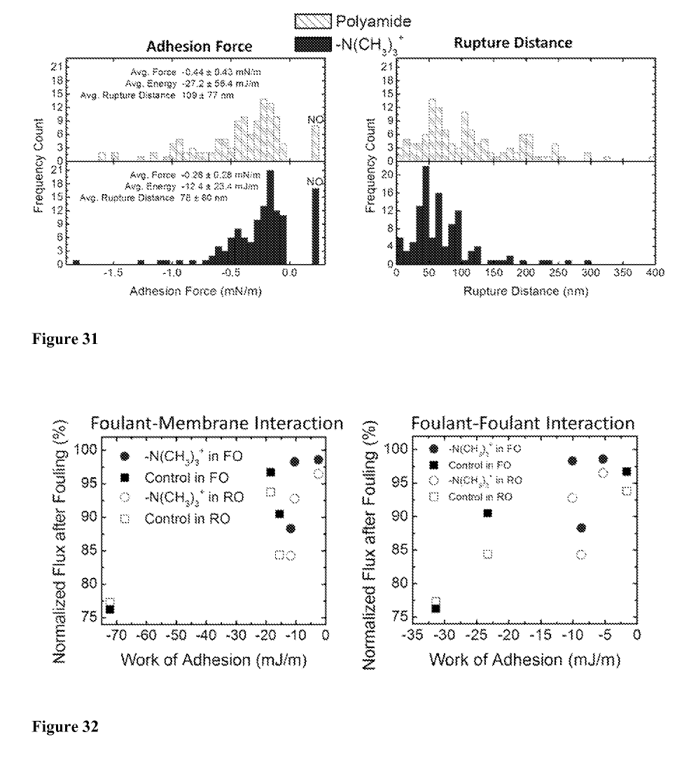

A direct correlation was not observed between the rupture distance and the fouling behavior (FIG. 30). It is possible that the positive charges at the surface of the superhydrophilic membranes give rise to attractive electrostatic forces between the negatively charged foulants and the membrane surface. These DLVO forces may be able to create an interaction at long-range distances. On the other hand, their magnitude of this interaction was significantly smaller than the forces between the superhydrophilic surface and the tight hydration layer, which prevented deep attraction wells to exist between foulants and the functionalized membranes.

The shape and the width of the distribution of adhesion forces also inform us about the type of surface interaction. The alginate-membrane attractive forces were very widely distributed for the control membranes (FIG. 26-27A). This is consistent with bridging mechanisms, whereby the divalent calcium ions in solution cross-link the carboxyls of the membrane surface with those of alginate molecules, enhancing the attachment of these molecules at the surface. On the contrary, this mechanism did not occur for the superhydrophilic membranes, whose surface carboxyl groups are overlain by positively-charged particles. Once a layer of alginate has formed at the surface, further bridging occurs between alginate and alginate molecules, resulting in the formation of a cross-linked alginate gel layer on the membrane surface. Therefore, in the case of alginate, fouling is controlled by bridging mechanisms and by foulant-foulant interactions. This observation explains the similar water flux losses in RO and FO for both membrane types, even when bridging could not occur between alginate and the superhydrophilic surfaces. In FO, this gel layer was loosely packed and easily removed from the membrane surfaces in the absence of calcium, as discussed above (FIG. 28).

The mechanism of BSA fouling is different. Protein adsorb to non-polar hydrophobic surfaces via dispersive and hydrophobic interactions. In case of hydrophilic materials, lower protein fouling has been observed due to unfavorable polar interactions and to the inability of protein molecules to displace the hydration layer and adsorb on the surface. In water treatment membrane operation, protein adsorption is more affected by hydrodynamic forces than by calcium effects. The resulting width of the distribution was found to be more condensed than in case of alginate (FIG. 26-27B). In the case of foulant-foulant interactions, the adhesion forces measured on the control membranes were significantly larger than those on the functionalized membranes. The BSA molecules deposited on the superhydrophilic nanoparticles without displacing the hydration layer, resulting in lower adhesive forces measured by AFM that correlated with lower fouling in both RO and FO experiments.

The SRNOM-membrane fouling mechanism is somewhere in between that of BSA and alginate. The SNROM molecules contain several functionalities, among which there are some carboxyl groups. In this invention, the adhesion forces and the fouling related to SRNOM were found to be very low even in the presence of calcium ions in solution. As a final note, when the average work of adhesion is plotted against the loss in water flux due to fouling, a positive correlation exists between these two parameters for both foulant-membrane and foulant-foulant measurements. In particular, the energies measured for foulant-foulant experiments scales well with the fouling rate (FIG. 32). These results confirm the capability of AFM intermolecular forces to predict the fouling behavior of dense membranes.

Antifouling Mechanism in FO. The fouling resistance observed for the superhydrophilic membranes is attributed to a number of concomitant mechanisms. The main mechanism of fouling resistance is attributed to affinity of the superhydrophilic surfaces to water. In the presence of hydrogen acceptor groups, the short-range acid-base forces promote the existence of an interfacial layer of tightly-bonded water molecule, which provides a barrier against the adhesion of foulants. Water molecules at this interface have low rotational and translational dynamics and their displacement occurs at the expense of a significant amount of enthalpy gain. Therefore, the strategy to fabricate fouling-resistance surfaces should aim to the maximization of the interfacial energy between the surface and water.

Simultaneous to this phenomenon, positively-charge nanoparticles at the membrane surface screen, neutralize, or simply overlain the layer of polyamide surface carboxyls, preventing the occurrence of a calcium bridging phenomenon with the carboxyl-rich fouling molecules. The positive charges at the surface of the nanoparticles might also give rise to electrostatic attraction with negatively-charged foulants.

Studies have underlined the effect of higher cross-flow in reducing fouling in membrane operations and in enhancing cleaning efficiency. In a system where the surface energetic play the most important role in preventing attachment of fouling molecules, such as that of the superhydrophilic membranes, the role of shear stress cannot be overly emphasized. The fouling resistance and the cleaning efficiency of the functionalized membranes can be further improved by optimizing the hydrodynamic conditions at the feed boundary layer. At high shear rate, the superhydrophilic surface would be rendered even more “slippery” and its dehydration by fouling molecules further thwarted.

While the invention has been particularly shown and described with reference to specific embodiments (some of which are preferred embodiments), it should be understood by those having skill in the art that various changes in form and detail may be made therein without departing from the spirit and scope of the present invention as disclosed herein.

1. A membrane comprising a layer of nanoparticles chemically bonded to the membrane surface.

2. The membrane of claim 1, wherein the membrane comprises a plurality of layers and the layers other than the first layer are electrostatically bonded to the nanoparticles of the first layer of nanoparticles.

3. The membrane of claim 1, wherein the membrane has from 1 to 10 layers of nanoparticles.

4. The membrane of claim 1, wherein the membrane is a reverse osmosis, forward osmosis, or ultrafiltration membrane.

5. The membrane of claim 1, wherein the nanoparticles are chemically bonded to the membrane surface via a linker group.

6. The membrane of claim 1, wherein the linker group is

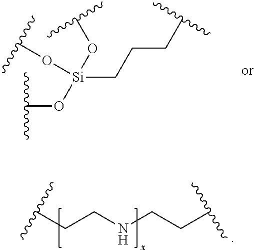

7. The membrane of claim 1, wherein the nanoparticles are metal nanoparticles, metal oxide nanoparticles, inorganic oxide nanoparticles, or combinations thereof.

8. The membrane of claim 1, wherein the membrane is a reverse osmosis membrane, a forward osmosis membrane, or an ultrafiltration membrane.

9. The membrane of claim 1, wherein the membrane is a composite membrane.

10. A method for forming a nanoparticle-functionalized membrane comprising the steps of:
a) optionally, functionalizing a membrane such that reactive functional groups are formed on the membrane surface; and
b) contacting the membrane with surface-functionalized nanoparticles such that the reactive functional groups on the membrane surface react with the surface-functionalized nanoparticles forming a nanoparticle-functionalized membrane.

11. The method of claim 10, wherein the membrane is contacted with surface-functionalized nanoparticles and a crosslinking agent.

12. The method of claim 10, wherein the surface-modified nanoparticles have the structure: 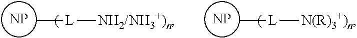
where 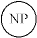
a nanoparticle, L is a linker group, R is a C₁ to C₁₀ alkyl group and n is from 200 to 1000.

13. The method of claim 12, wherein the linker group is

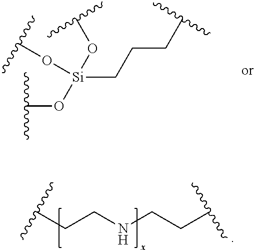

14. The method of claim 10, wherein the surface-modified nanoparticles are polymer-functionalized nanoparticles, where the polymer has functional groups that can react with the functional groups on the membrane surface.

15. The method of claim 14, wherein the polymer is polyethyleneimine.

16. The method of claim 10, wherein the membrane is functionalized by exposure to an oxygen plasma.

17. The method of claim 10, wherein the nanoparticles are metal nanoparticles, metal oxide nanoparticles, inorganic oxide nanoparticles, and combinations thereof.

18. (canceled)

19. A device comprising the membrane of claim 1.

20. The device of claim 19, wherein the device is an ultrafiltration devices, reverse osmosis (RO) devices, forward osmosis (FO) devices, pressure retarded osmosis (PRO) devices, nanofiltration (NF) devices, microfiltration (MF) devices, and membrane bioreactors (MBR).
